SEQUENCE LISTING (10 sequences)

SEQ ID NO: 1 - DNA, 47 bp, Homo sapiens
ctcaaaaaaaaaaaaaaaaaaaattttttttttttttttttggacaa

SEQ ID NO: 2 - DNA, 20 bp, Homo sapiens
ccatcaaaaatttttggaca

SEQ ID NO: 3 - DNA, 26 bp, Homo sapiens
actagagtctgtagtatatacaggct

SEQ ID NO: 4 - DNA, 16 bp, Homo sapiens
gggagttctgggcatg

SEQ ID NO: 5 - DNA, 16 bp, Homo sapiens
ggcatgttcatttgcc

SEQ ID NO: 6 - DNA, 32 bp, Homo spaiens
atttggttttctttccttcctgatagtatggc

SEQ ID NO: 7 - DNA, 28 bp, Homo sapiens
aattacaaataaccccacaccaagtcag

SEQ ID NO: 8 - DNA, 14 bp, Homo sapiens
acacatatcacata

SEQ ID NO: 9 - DNA, 14 bp, Homo sapiens
taacaaggagtaac

SEQ ID NO: 10 - DNA, 30 bp, Homo sapiens
cctgacctcatgatcatcctgaggcctccc

(19) United States
(12) Patent Application Publication
(10) Pub. No.: US 2019/0080045 A1
(43) Pub. Date: Mar. 14, 2019

(54) DETECTION OF HIGH-RESOLUTION STRUCTURAL VARIANTS USING LONG-READ GENOME SEQUENCE ANALYSIS

(71) Applicant: The Jackson Laboratory, Bar Harbor, ME (US)

(72) Inventors: Chia-Lin Wei, West Hartford, CT (US); Chee Hong Wong, West Hartford, CT (US)

(21) Appl. No.: 16/130,535

(22) Filed: Sep. 13, 2018

Related U.S. Application Data
(60) Provisional application No. 62/676,003, filed on May 24, 2018.
(60) Provisional application No. 62/558,053, filed on Sep. 13, 2017.

(51) Int. Cl. G06F 19/16; G06F 19/22; G06F 19/28; G06F 19/24

(52) U.S. Cl. CPC G06F 19/16; G06F 19/24; G06F 19/28; G06F 19/22

(57) ABSTRACT

A method of determining the presence of a novel structural variation in a genome using long-read genome sequence fragments includes a process of aligning, filtering ranking and linking long-read sequence fragments against a reference genome. Presence of a novel structural variation is present in said genome can be determined when said linked alignment contains multiple linked fragments that are mapped to a single locus, referred to as a split-read.

### CROSS-REFERENCE TO RELATED APPLICATIONS

This application claims the benefit under 35 U.S.C. § 119(e) of U.S. Provisional application Ser. No. 62/558,053 filed Sep. 13, 2017 and U.S. Provisional application 62/676,003 filed May 24, 2018, the disclosure of each of which is incorporated by reference herein in its entirety.

### 1. INTRODUCTION

The present disclosure concerns a method of determining the presence of a novel structural variation in a genome using long-read genome sequence fragments. By a process involving aligning, filtering ranking and linking long-read sequence fragments against a reference genome, presence of a novel structural variation in said genome can be determined when said linked alignment contains multiple linked fragments that are mapped to a single locus, referred to as a split-read.

### 2. BACKGROUND

Genomic structural variation is prevalent in the human genome and includes deletions, insertions, duplications, inversions, and translocations. Collectively, these structural variants (SVs) account for a significant portion of genome heterogeneity between individuals and human populations. The complexity and diversity of genome structure changes have been shown to influence genome evolution and genetic diversity among populations, while specific SVs are associated with disease susceptibility. Many cancer genomes have been found to harbor significant structural variation, and specific SVs are considered instrumental in promoting tumor progression by disrupting gene structures, dysregulating gene expression, creating fusing transcription units or increasing gene copy number. The detection of specific SVs can be used as the basis for tumor classification and potentially of prognostic value for tumor severity and therapeutic response. However, despite the prevalence of SVs and their particular relevance to cancer, the molecular organization of various SV classes and the mechanisms that generate them are not well understood. This is in large part due to the inability of current technologies to uncover the full spectrum of SVs with high specificity at nucleotide-level resolution.

Advances in sequencing technology coupled with improvements in computational algorithms have greatly enhanced our understanding of the abundance, diversity, and molecular features of SVs across human populations and disease. However, current sequencing approaches that generate high coverage, paired-end short-read sequencing data, combined with split read mapping methods lack the precision and sensitivity necessary for the detection of many types of SVs, particularly in regions of repetitive sequence. Specifically, paired-end short reads are not sufficiently sensitive to detect small SVs, which require a high depth of sequencing coverage to achieve high specificity, and lack the nucleotide-level of detail for analysis of the breakpoints that flank SVs. They are also unable to decipher complex SV patterns or provide haplotype phase of SVs in diploid genomes. Thus, there is an ongoing effort to develop effective long-read sequencing approaches for the characterization of SVs.

What is therefore needed is a method that harnesses the newly-developed capabilities of long-read sequencing techniques to detect a full spectrum of SVs with high specificity and sensitivity.

### 3. SUMMARY OF THE INVENTION

A method of determining the presence of a novel structural variation in a genome is disclosed. The method comprises: a) providing a plurality of long-read genome sequences derived from a genome; b) aligning said long-read genome sequences with a reference genome sequence to produce a plurality of alignments by using alignment parameters configured for low sequence similarity; c) filtering said plurality of alignments by removing low quality alignments to yield remaining alignments based on an alignment parameter; d) ranking said remaining alignments based on (i) a probability of random hit, and (ii) an alignment score; e) selecting a seed candidate alignment, wherein said seed candidate alignment has a highest rank as compared to the remaining alignments; f) linking said seed candidate alignment with said remaining alignments to create a linked alignment extension having a combined alignment score, said linking is performed by using read coordinates of said seed candidate alignment in vicinity to read coordinates of said remaining alignment to cover a maximal sequence length; g) repeating step e) and step f) to obtain a plurality of linked alignment extensions; h) selecting from step g) a best linked alignment extension that has a highest combined alignment score; and i) determining whether a novel structural variation is present in said genome, wherein when said best linked alignment extension contains multiple linked alignments that are mapped to a single locus is indicative of the presence of a novel structural variation.

These and other features can be appreciated from the accompanying description of certain embodiments which are discussed in relation to the accompanying drawing figures.

### 4.1 BRIEF DESCRIPTION OF THE DRAWINGS

FIG. 1 is a schematic flow diagram of an example long-read sequencing process.

FIG. 2A-D provides schematic illustrations of alignment processes performed in embodiments of method of determining the presence of a novel structural variation in a genome as disclosed herein.

FIG. 3A-B provides a histogram and an annotated current trace. FIG. 3A shows a histogram illustrating the ratio of the observed versus expected instances of all 1,024 5-mers. The 4 under detected homopolymers are highlighted. FIG. 3B is an annotated current trace for the segment harboring base-called deletion. The current trace indicates the clear presence of the two homopolymers (marked (A)20 and (T)18) rather than the deletion flanked by (A)5 and (T)5. Shown in FIG. 3B are: SEQ ID NO: 1: ctcaaaaaaaaaaaaaaaaaaaattttttttttttttttttggacaa and SEQ ID NO: 2 ccatcaaaaatttttggaca.

FIG. 4 is a schematic flow diagram that depicts an exemplary process of assigning breakpoints to their corresponding genomic features based on the gene model.

FIG. 5A-B provide summary tables. FIG. 5A is a tabulated summary of the validated structural variations by PCR and FIG. 5B is a table showing numbers of high confidence SVs previously described in HCC1187 detected by nanopore sequencing.

FIG. 6A-B provides a histogram and graphs. FIG. 6A is a histogram showing the yield of 15 nanopore long-reads of different chemistries. FIG. 6B shows a set of three graphs of read length versus percentage identity that shows the accuracy of nanopore reads from different versions of chemistries and run protocols.

FIG. 7A-B provides two graphs. FIG. 7A is a graph of log of read counts versus percentage identity which indicates that accuracy and read counts from runs with different run protocols and pore speeds. FIG. 7B is a graph showing genome coverage versus depth from the 7.9 Gb of the nanopore data generated in the experimental study.

FIG. 8A-B provides a graph and chromosomal diagram. FIG. 8A is a graph of the percentage of the genome covered by short versus long read data of different depths. FIG. 8B shows a chromosomal region (chr1: 25,732,083-25,735,365) covered by a 14.7-Kb nanopore read and by185 Gb, 60× of short-read data.

FIG. 9A-C provides graphs showing length distribution of nanopore reads from 12 Kb target template size and from 3 Kb target template size, in FIG. 9A and FIG. 9B, respectively.

FIG. 9C shows the length distribution of PacBio reads from the same 12 Kb target template size.

FIG. 10 shows a 50 Kb nanopore 2D read aligned to reference human genome (chr12: 9,305,878-9,356,863) with 95% average identity.

FIG. 11 is a read alignment summary including different classes of SVs detected by the long read SV determination method disclosed herein.

FIG. 12A-B provides a graph and a genome diagram. FIG. 12A is a graph showing the percentage of reads containing breakpoints over a span of read lengths. FIG. 12B is an illustration of a structural variation composed of two translocations detected from a 32.5 Kb nanopore read.

FIG. 13A-B provides tables of the total counts (FIG. 13A) the log-likelihood (FIG. 13B) of the adjacent SVs phased by the multi-breakpoint long reads.

FIG. 14 is a visualization of a short tandem duplication detected by the disclosed long read analysis method.

FIG. 15A-B provides tables with FIG. 15A and FIG. 15B showing numbers of structural variants and a summary of the variants from the different SV classes.

FIG. 16A-B provides tables of SV data. FIG. 16A is a table of numbers of SVs identified by LUMPY from different depths of short-read data. FIG. 16B is a table including numbers of high confidence SVs previously described in HCC1187 detected by nanopore sequencing.

FIG. 17A-F provides examples of validated breakpoints and their detailed junction sequences. Long read-to-reference genome alignments, junction sequences and affected genes are shown in each SV class. The micro-homologous sequences shared between junctions are highlighted in red boxes. The SVs depicted are: TDJ (FIG. 17A); INS (FIG. 17B); DEL (FIG. 17C); INV (FIG. 17D); TLC (FIG. 17E). The translocation t(1; 8) identified is consistent with translocation identified previously by spectral karyotyping (SKY)27 with base resolution. FIG. 17F shows amplified PCR fragments across breakpoints for each of the SVs shown in FIG. 17A-E, which were analyzed by Bioanalyzer (Agilent Technologies). L indicates molecular size markers. Sequences shown in FIG. 17 include SEQ ID NO: 3 actagagtctgtagtatatacaggct; SEQ ID NO: 4 gggagttctgggcatg; SEQ ID NO: 5 ggcatgttcatttgcc; SEQ ID NO: 6 atttggttttctttccttcctgatagtatggc; SEQ ID NO: 7 aattacaaataaccccacaccaagtcag; SEQ ID NO: 8 acacatatcacata; and SEQ ID NO: 9 taacaaggagtaac.

FIG. 18A-B provides graphs showing span distributions of repeat-rich SVs and the presence of micro-insertions within SV junctions detected by the disclosed long-read method.

FIG. 18A shows the Span distribution of INV, TDJ and TDC and FIG. 18B shows the span distribution of DEL, INS and INDEL.

FIG. 19A-B provides graphs. FIG. 19A is a graph showing a fraction of regions overlapped with repeats among different SV classes and FIG. 19B is a graph showing relative percentages of the major repeat types across different span sizes.

FIG. 20A-B provides graphs. FIG. 20A shows relative percentages of repeats across different span sizes in simple DEL and FIG. 20B shows relative percentage of repeats across different span sizes in simple INS.

FIG. 21A-B provides a graph and a pie chart of sequence results. FIG. 21A is a graph showing the percentages of SVs with micro-insertions and the size distribution of the inserted sequences and FIG. 21B is a pie chart showing the identity of the micro-insertions.

FIG. 23A-B provides chromosome diagrams. FIG. 22A is an illustration of an insertion of a 1.7 Kb CBX3 retrotransposed pseudogene in chromosome 15 revealed by a 24.8 Kb read (WTD13:1125) and FIG. 22B is an illustration of a confirmed TDJ of 1.87 Mb on chromosome 18 revealed by a 3.0 Kb read (WTD02:4697). Sequence shown in FIG. 22B is SEQ ID NO: 10 cctgacctcatgatcatcctgaggcctccc.

FIG. 23A-C provides a chromosome chart and two graphs of results. FIG. 23A is a circular chromosome chart that illustrates that genome-wide distribution of the SVs and their associated breakpoints density. From outer circle to inner circle: Red: indicates measured breakpoint density; Grey: indicates reference average density of 22 breakpoints/Mb; Blue: indicates TDC; Purple: indicates TDJ (with span size <20 Mb); Green: indicates INV; Magenta: indicates TLC (with pair counts ≥4) at 1 Mb bin size. FIG. 23B is a graph showing a fraction of regions with transcribed genes in regions of the top and bottom 10% breakpoint densities. BP, indicates breakpoint. The P value was calculated by the Mann-Whitney test. FIG. 23C is a graph of ICP versus breakpoint counts and shows the trend of increasing ICP with increasing number of breakpoints. In the plots, the breakpoint and ICP were calculated for every chromosome segments of 138 HindIII sites. The ICP values were then grouped based on the breakpoint counts as indicated on the x-axis. The R value is the Pearson's correlation coefficient on the underlying, ungrouped data.

FIG. 24A-B shows graphs. FIG. 24A illustrates enrichment of breakpoint from each SV class distributed along different genomic features and FIG. 24B illustrates the distribution of the breakpoints associated with TDC along different genomic features of transcription.

FIG. 25A-B provides scaling plots and histograms illustrating results of studies. FIG. 25A is a multidimensional scaling (MDS) plot of SV-genes in the BRCA (breast carcinoma) dataset within the TCGA (cancer genome atlas). FIG. 25B illustrates control of the multidimensional scaling (MDS) analysis: top left section is a histogram of gene expression from SVs-genes (log 2 transferred); top right section is a histogram of gene expression from the control genes. Similar expression profiles and the equivalent numbers of SVs-genes are shown (log 2 transferred); lower left section is an MDS plot of the expressions of the SVs-genes by sample-wise permutation; and lower right section is an MDS plot of the expressions from the control genes. All data are from the breast carcinoma (BRCA) dataset within the cancer genome atlas (TCGA).

FIG. 26A-D provides a flow chart. FIG. 26A shows start of flowchart, which is continued as FIG. 26B, which continues as FIG. 26C, which continues as FIG. 26D. The overall flow chart illustrates an embodiment of the structural variation determination method disclosed herein.

FIG. 27A-C shows results demonstrating the prevalence of SV heterozygosity in HCC1187 genome. FIG. 27A is a gel showing PCR products corresponding to different haplotypes in two validated SVs. Independent repeats=2. FIG. 27B provides a schematic diagram showing reads supporting both SV and the normal genotypes from the same locus were visualized in IGV browser. FIG. 27C is a table showing heterozygosity analysis from 50 randomly selected loci from each of the seven SV types.

FIG. 28 is a diagram showing the logic and criteria used to define seven SV types using embodiments of methods of the invention. High-scoring Segment Pair (HSP) i between the read segment and the reference segment is denoted by Qi and Si respectively. Linked alignment extensions with 3 segments will have 3 HSPs indicated by Q1:S1, Q2:S2, and Q3:53. Each segment span is denoted by (Start,end] as per UCSC 0-start, half-open coordinate system. sDiff between reference segment Si and Si+1 is given by Si+1(start)-Si(end). qDiff between read segment Qi and Qi+1 is given by Qi+1(start)-Qi(end).

### 4.2 DEFINITIONS

The following definitions of terms apply to the disclosure herein:

“About” is defined as at least close to and including a given value or state (preferably within 10%).

A “long-read genomic sequence” (also referred to as “long-read data” herein) is a sequence of nucleotides containing 10,000 or more bases for single-stranded DNA, or 50,000 or more base pairs for double-stranded DNA.

A “long read coordinate” is a specific numerical coordinate assigned to each nucleotide within a genomic sequence obtained by a long-read sequencing process.

“Nucleic acid” and “polynucleotide” are terms that can be used interchangeably herein, and refer to both RNA and DNA, including cDNA, genomic DNA, synthetic DNA, and DNA or RNA containing nucleic acid analogs. Polynucleotides can have any three-dimensional structure. A nucleic acid can be double-stranded or single-stranded (e.g., a sense strand or an antisense strand). Non-limiting examples of polynucleotides include chromosomes, chromosome fragments, genes, intergenic regions, gene fragments, exons, introns, messenger RNA (mRNA), transfer RNA, ribosomal RNA, siRNA, micro-RNA, ribozymes, cDNA, recombinant polynucleotides, branched polynucleotides, nucleic acid probes and nucleic acid primers. A polynucleotide may contain unconventional or modified nucleotides

A“nucleotide” is a molecule that when joined together form the structural basis of polynucleotides, e.g., ribonucleic acids (RNA) and deoxyribonucleic acids (DNA). A “nucleotide sequence” is the sequence of nucleotides in a given polynucleotide. A nucleotide sequence can also be the complete or partial sequence of an individual's genome and can therefore encompass the sequence of multiple, physically distinct polynucleotides (e.g., chromosomes).

An “individual” can be of any species of interest that comprises genetic information. The individual can be an eukaryote, a prokaryote, or a virus. The individual can be an animal or a plant. The individual can be a human or non-human animal.

A “genome” of an individual member of a species comprises that individual's complete set of chromosomes, including both coding and non-coding regions. Particular locations within the genome of a species are referred to as “loci”, “sites” or “features”. “Alleles” are varying forms of the genomic DNA located at a given site. In the case of a site where there are two distinct alleles in a species, referred to as “A” and “B”, each individual member of the species can have one of four combinations: AA; AB; BA; and BB. The first allele of each pair is inherited from one parent, and the second from the other.

“Alignment” or “aligned fragment”—the terms alignment and aligned fragment can be used interchangeably herein and both denote a genomic string or segment that has been matched to a locus of a reference genome.

A “structural variation” (“SV”) is any change in an individual nucleotide sequence compared to a reference sequence.

An “inversion” (“INV”) is a mutation in which a segment of DNA that is reversed in orientation with respect to the rest of the chromosome.

An “insertion” (“INS”) is a mutation in which a sequence of DNA is added with respect to the reference genome.

A “deletion” (“DEL”) is a mutation in which a sequence of DNA is lost with respect to the reference genome.

An “indel” (INDEL”) is a mutation involving both insertion and deletion of bases in the genome.

A “duplication” is a sequence alteration whereby the copy number of a given region is greater than the reference sequence.

A “tandem duplication” (“TD”) is a duplication consisting of two identical adjacent regions.

A “tandem duplication split-read” (“TDSR”) is a tandem duplication that does not align contiguously to the reference genome, and is therefore broken into two or more fragments, in which adjacent fragments align to non-adjacent locations in the reference genome.

A “tandem duplication complete” (“TDC”) is a tandem duplication in which a single fragment contains the duplication region.

A “translocation” (“TLC”) is a change in position of a chromosomal segment within a genome that involves no change to the total DNA content. Translocations can be intra-chromosomal (“CTLC”—cis-chromosomal translocation) or inter-chromosomal (“TTLC”-trans-chromosomal translocation).

The following terms are parameters used in the Smith-Waterman algorithm which determines the similarity between two strings of DNA.

A “gap penalty” is a scoring penalty for opening or extending gaps.

A “match score: (“r”) is a numerical value (e.g., 1) attributed to a match of two compared elements in the substitution matrix (i.e., for an entry s(α,β), when base a=base b).

A “mismatch cost” (“q”) is a numerical value (e.g., −1) attributed to a mismatch of two compared elements in the substitution matrix (i.e., for an entry s(α,β) when base a≠ base b).

“Wₖ” is a numerical value attributed as a penalty to a gap of length k.

A “gap existence cost” (“a”) is a numerical value (e.g., 0) used in the calculation of Wₖ according to the equation Wₖ=gap existence cost (a)+gap extension cost(b)*k.

A “gas extension cost” (“b”) is a numerical value (e.g., 2) used in the calculation of Wₖ according to the equation Wₖ=gap existence cost (a)+gap extension cost(b)*k.

### 5. DETAILED DESCRIPTION

Disclosed herein is a method that employs long-read genomic sequence data (hereinafter termed “long-read data”) to determine the presence of a novel structural variation in a genome and characterize their genomic breakpoints with high specificity and sensitivity. To exploit the value of long reads in SV detection, a computational analysis pipeline is provided, which optimally performs read alignments and logically defines the full spectrum of SVs, including complex SVs enriched in repetitive DNA elements. Embodiments of the computational analysis pipeline of the invention may also be referred to herein as “Picky”). The method of analyzing long-read data to determine SVs in a genomic sample as disclosed herein comprises an end-to-end analysis pipeline that includes three general phases: 1) alignment of long-read data obtained from a long-read sequencing process to a reference genome; 2) optimal alignment merge/selection; and 3) SV classification. The analysis is performed using computer-readable code (i.e., one or more programs or scripts) executed on a computing system.

### 5.1 Providing a Plurality of Sequences of Long-Read Data

The determination of structural variations begins with a long-read sequence procedure that generates a plurality of long-read genomic sequences. Several different long-read sequencing techniques that generate long-read data have been developed and any of these techniques can be used to produce the data used for the structural variation analysis disclosed herein. For example, instruments from both Pacific Biosciences™ and Oxford Nanopore™ platforms produce read lengths in the thousands of bases per read. Pacific Biosciences uses optical detection of a sequencing-by-synthesis reaction that occurs inside a waveguide, while Oxford Nanopore uses nanopores for detection.

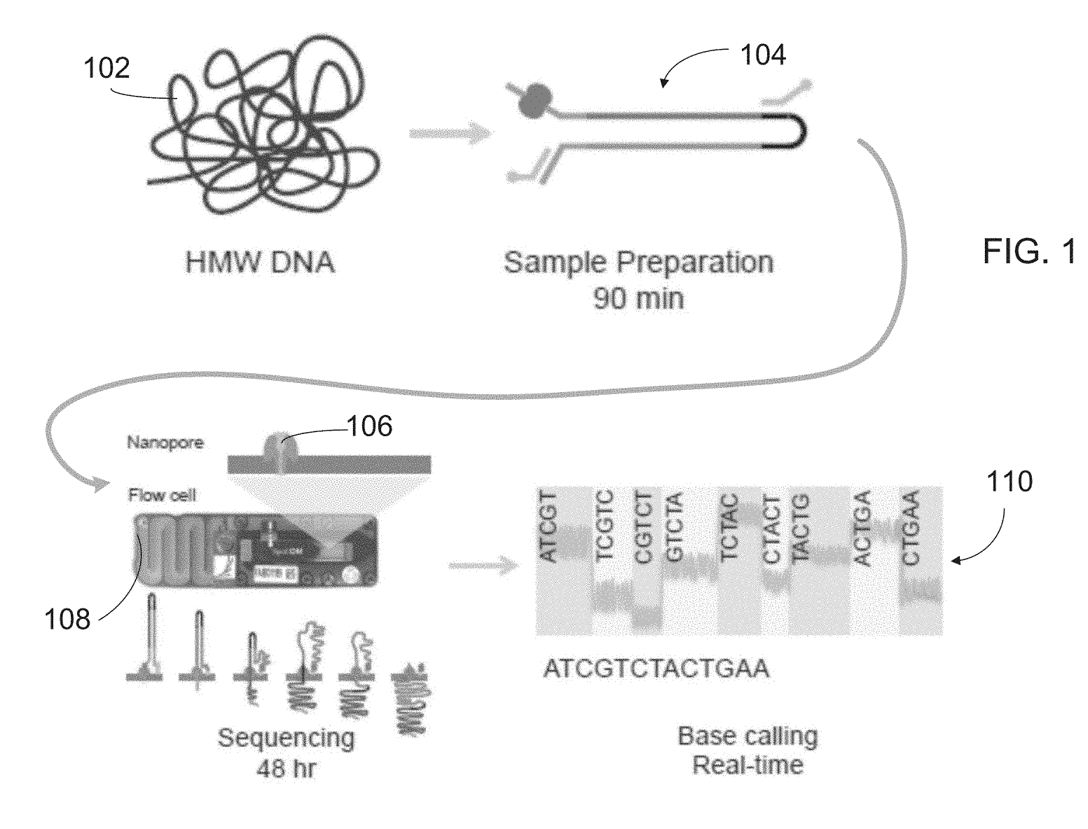

FIG. 1 illustrates an exemplary long sequencing process based on the Oxford Nanopore technique that can be used to provide a plurality of long-read genomic sequences for the structural variation determination method disclosed herein. High molecular weight DNA 102 is bridged by a hairpin adaptor 104 to provide both template and complementary strands of DNA (both 1-D and 2-D strands). Use of 2D sets improves accuracy by aligning the template and complement sequences and resolving any ambiguous base identifications in a final read output. The template and complementary DNA is then fed through a nanopore 106 in the sequencing instrument 108. Long read genomic data 108 is then output from the sequencing instrument.

Recent progress in nanopore single-molecule sequencing and other long-read sequencing techniques offers the ability to extend sequencing read length and throughput, features that can facilitate detection and analysis of SVs in large complex genome. For instance, the nanopore platform sequences individual DNA molecules by passing them through nanometer-scaled pores and measuring changes in the electric current across the pore caused by the transiting nucleotides. These current changes are then computationally deconvoluted to reveal the identity of the bases. Unlike conventional sequencing-by-synthesis technology platforms, nanopore sequencing can generate reads of 10-100 Kb in real-time. Other long-read techniques have generated similar results. Such long-read sequencing techniques improve the speed, read length and throughput necessary for comprehensive and unbiased SV profiling and would be particularly useful for resolving complex structural rearrangements in cancer genomes.

### 5.2 Aligning Long-Read Data to a Reference Genome

The output of the long-read sequencing process comprises a plurality of long-read genomic sequence fragments. These fragments, along with a reference genomic sequence, comprise the input data used in the initial alignment step. The fragments of long-read data are compared to the bases of a reference genome, matches and mismatches between the fragments of long-read data and the reference genome are determined. To perform the alignment, an alignment program, such as LAST (Local Alignment Search Tool) [Kielbasa, et al. Genome Res. 21, 487-493 (2011) and Frith, et al., BMC Bioinformatics 11, 80 (2010)] is accessed and executed to perform the genomic alignment. While long-read sequencing techniques such as the Oxford nanopore technique produce long sequences with high-throughput, their efficiency can come at the cost of a high error rate. To accommodate a high error rate for long-read sequencing, the alignment process was configured with parameters adapted for low similarity between the long-read data and the reference genomic data. For sequences in which a high degree of divergence (similarity on the order of 75% to 95%) is expected, the ratio between reward scores for matches and penalties for mismatches is set relatively high (e.g., >0.5) to boost sensitivity. In certain embodiments, the ratio can be set to different values, e.g., about 0.1 to about 0.2, about 0.2 to about 0.3, about 0.3 to about 0.4, about 0.4 to about 0.5, about 0.5 to about 0.6, about 0.6 to about 0.7, about 0.7 to about 0.8, or about 0.8 to about 0.9 depending on the known accuracy of the long read process used. Recommended settings for low similarity configurations are provided by the megaBLAST greedy alignment algorithm. Exemplary parameters that can be used for alignment according to the megaBLAST greedy algorithm are: match score (reward)=1; mismatch cost (penalty)=−1; gap existence cost (open)=0; and gap extension cost=2.

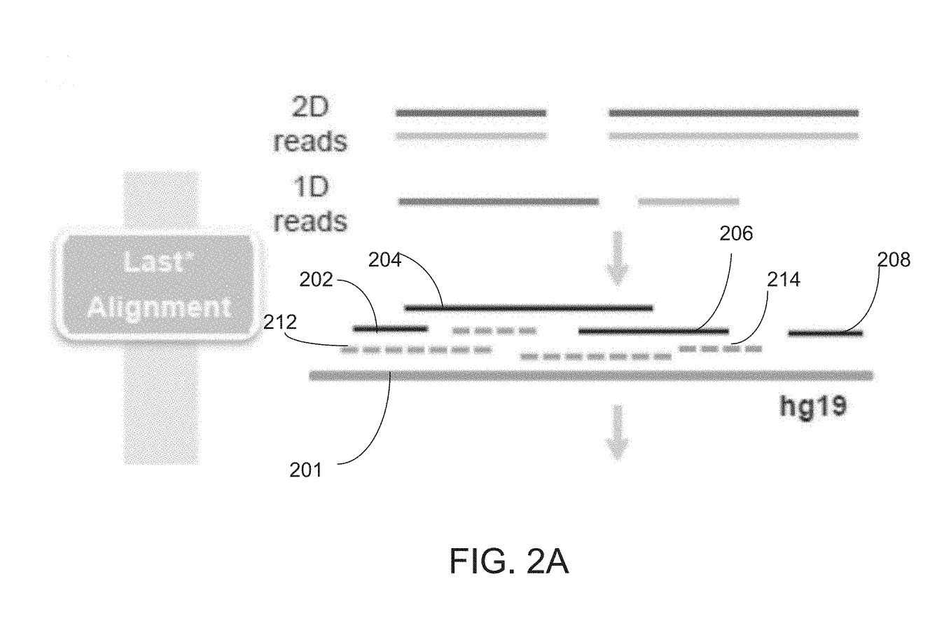

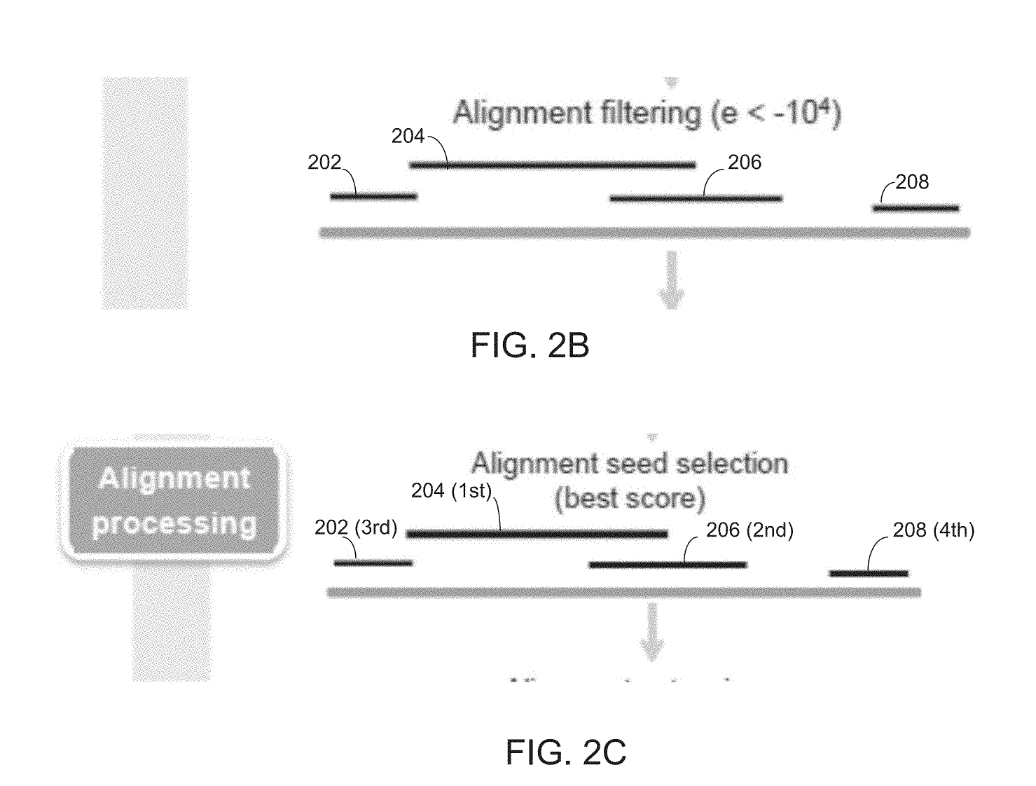

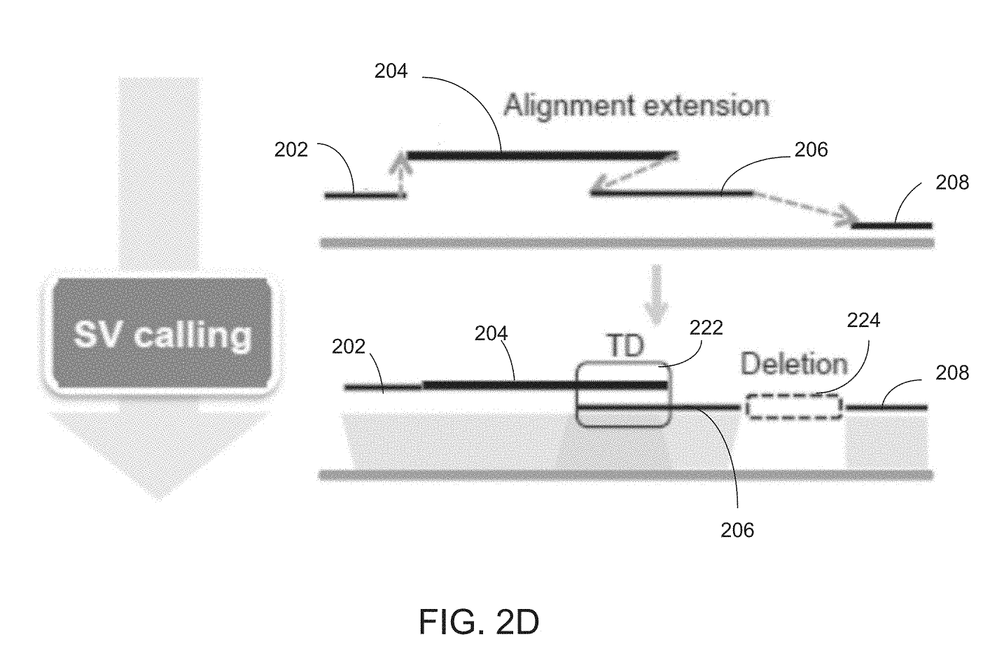

Reference is now made to FIG. 2A, which is a schematic illustration of an example alignment process. A plurality of 1-dimensional and/or 2-dimensional long-read genomic sequence fragments are shown as the inputs to the alignment process, which seeks to align the plurality of genomic fragments to a reference genomic sequence 201. At the bottom of FIG. 2A, the plurality of fragments are shown being aligned at particular loci along the reference sequence 205 to which their sequences match. The alignment score of each fragment is the core obtained by applying the alignment algorithm (e.g., megaBLAST greedy alignment algorithm) in which matches, mismatches, and gap penalties are used to determine whether the alignment is of high quality (i.e., has a high alignment score) or relatively lower quality (i.e., has a lower alignment score). In the depicted example, fragments 202, 204, 206 and 208 represent high quality alignments and fragments e.g., 212, 214 represent low quality alignments. In addition to the alignment score, an EG2 parameter is used which measures the expected number of alignments with greater or equal score between two randomly-shuffled sequences of length of one billion each. This parameter is indicative of whether a scored alignment could occur randomly. Another parameter that can be used is percentage identity (“% identity”) which, like the alignment score, also indicates the similarity between a fragment and the locus of the reference genome to which it is aligned.

### 5.3 Filtering the Aligned Fragments

After the plurality of long-read data fragments have been aligned, and alignment scores and EG2 value have been assigned to each fragment, the plurality of fragments are evaluated for their quality. In some embodiments, low quality alignments are filtered out based on low alignment score or low percentage identity and EG2 criteria. For example, aligned fragments having an EG2 score greater than a threshold value or less than an identity % threshold value are considered to have low quality and are removed. In certain embodiments, the EG2 score threshold is 5.0e⁻¹³ to 8.0e⁻¹³, 8.0e⁻¹³ to 1.1e⁻¹², 1.1e⁻¹² to 1.4e⁻¹², 1.4e⁻¹² to 1.7e⁻¹², 1.7e⁻¹² to 2.0e^{-—}, 2.0e⁻¹² to 2.3e⁻¹², or 2.3e⁻¹² to 2.6e⁻¹². In addition, in certain embodiments, the % identity threshold is about 30% to about 40%, about 40% to about 50%, about 50% to about 60%, or about 60% to about 70%.

FIG. 2B, which follows from FIG. 2A, schematically illustrates an example result of a filtering step. As indicated in FIG. 2B, the low quality alignments shown in FIG. 2A, e.g., 212, 214 have been removed, leaving only the high quality aligned fragments 202, 204, 206, 208 remaining for further processing. If there are no aligned fragments remaining after filtering, the read can be reported as being unmapped. If, alternatively, there is only one aligned fragment remaining after filtering, the read is reported as being uniquely mapped and no structural variation can be identified. In both of these cases, the determination process ends at this point.

### 5.4 Ranking the Remaining Aligned Fragments

In certain embodiments, the high quality aligned fragments remaining after the low quality aligned fragments have been removed are ranked in a cardinal order according to both EG2 value (lowest) and alignment score (highest). In some implementations, the EG2 criterion is weighed higher, so that, for example, if one particular aligned fragment has the lower EG2 score, while a different aligned fragment has the highest alignment sore, the aligned fragment with the lowest EG2 is ranked higher than the aligned fragment with the highest alignment score. Generally, however, the fragment with the lowest EG2 score will have the highest alignment score in the vast majority of cases. When a ranking is complete, the number “n” of remaining aligned fragments are ordered by rank in terms of a “best” fragment, “second best” fragment, and so on up to an nth best fragment. Referring to FIG. 2C, which follows from FIG. 2B, in the illustrated example, the aligned fragments 202, 204, 206, 208 have been ranked in the following order: fragment 204—best score; fragment 206—2nd best score; fragment 202—third best score; and fragment 208—fourth best (lowest) score. In some implementations, to further ensure the quality of the aligned fragments used for analysis, the ranked aligned fragments are filtered a second time, with fragments that have an EG2 value less than 1e−49 and an identity percentage score within ten percent (10%) of the identity percentage of the highest ranked aligned fragment. This additional filtration step reduces the variance in quality between the remaining aligned fragments.

The retained aligned fragments can be subdivided into 3 subgroups: i) an ‘exact’ subgroup comprised of fragments that share the exact same start and end long-read coordinates but having different start and end genomic coordinates; ii) a ‘subset” subgroup comprised of fragments having long-read coordinates that are an exact sub-span of the representative fragment of the subgroup (the fragment having a lowest EG2 score and highest alignment score or % identity with respect to the reference genome); and iii) a “similar” subgroup that comprised of fragments having 95% reciprocal overlap and % identity difference ≤5 with respect to the representative fragment of the subgroup. The subgroups are exemplary, and more or fewer subgroups can be used with different criteria. The main purpose of establishing the subgroups is to make the long read analysis more efficient by attempting to sort out and use alignments that have similar quality, which improves error rates and precision.

### 5.5 Selecting a Seed Candidate Alignment

Once the non-filtered aligned fragments remaining have been ranked, a seed alignment is selected for a seed-and-extension algorithm that is used to link fragments together to maximize coverage for each long read. In certain embodiments, a “greedy” seed-and-extension algorithm can be used. The seed-and-extension algorithm starts with selection of a seed candidate group for each of the subgroups of remaining aligned segments. The seed group is a group of alignment fragments that is parsed for long-read coordinates to determine whether the members of the group can be linked together to increase the span of a continuous string of bases. For each subgroup, the first seed candidate selected is the aligned fragment with the highest rank. This seed candidate is then combined with any other fragments in the subgroup having the same or about the same EG2 value as the selected candidate, to produce a seed group. If the seed group produced contains greater than a threshold number (e.g., 5 to 10) aligned fragments, a selected number of the fragments of the seed group (e.g., the top 200) are selected as potential linkers. In certain embodiments, the threshold number of fragments is 4, 5, 6, 7, 8, 9 or 10 fragments. Additionally, the number of fragments of the seed group selected as potential linkers can be set to about 140 to 160, about 160 to 180, about 180 to about 200, about 200 to about 220, about 220 to about 240 or about 240 to about 260. If there are fewer than the set number of alignments in the seed group, the number of potential linker fragments can be iteratively increased by including successive fragments within EG2 value bins. In other words, fragments can be added starting with the EG2=0 bin, increasing to the 0<EG2<=1e⁻³⁰⁰ bin, and so on to the 1e⁻³⁰⁰<EG2<=1e⁻²⁰⁰ bin, etc. until the number of potential linker fragments reaches a selected number.

### 5.6 Linking the Seed Candidate Alignment with Remaining Alignments

After seed groups have been assembled, the process of linking and extension starts with selection of the highest ranking of the seed group as a seed candidate alignment for linking and extension. A second alignment of the seed group is then selected, and it is then determined whether the second alignment can be linked to the seed candidate alignment, based on whether the long-read coordinates of second alignment overlap with the long-read coordinates of the seed candidate alignment. Alternatively, if there is no overlap, linking can also occur when a termination point of the second alignment is within 500 bases of a termination point of the seed candidate alignment (i.e., when a gap between the seed candidate alignment and the second alignment is less than 500 bases wide). If the first of these conditions is met (overlap), it is then determined whether the overlap between the seed candidate alignment and the second alignment covers a threshold percentage percent or more of either alignment. In certain embodiments, the threshold overlap percentage is about 30% to 40%, about 40% to about 50%, about 60%, or about 60% to about 70%. If the overlap is higher than the overlap threshold, the second alignment is disqualified as a potential linker (extender). If, conversely, there is no overlap and a gap of less than 500 base gap, or if there is an overlap that is less than the overlap threshold, then the second alignment is linked to the seed candidate alignment as a combined fragment. The linking procedure is repeated, with the combined alignment(s) standing in the place of the original seed alignment for each repetition, until either the entire coordinate span of the long-read has been covered, or there are no further alignments in the seed group to link.

It is noted that in alternative embodiments, it is possible to start with seed candidates other than the highest ranked alignment. However, the highest ranked alignment will tend to be the longest fragment that aligns well with the reference genome, and therefore tends to provide a suitable initial fragment for the linking process.

An illustration of the linking and extension process is shown in FIG. 2D, which follows from FIG. 2C. As shown, the long-read coordinate of the downstream end of fragment 202 overlaps the long-read coordinate of the upstream end of fragment 204, and the amount of overlap is less than 50 percent of the length of either fragment. Fragment 202 and fragment 204 are then linked together. Turning to the next fragment 206, the long-read coordinate of the downstream end of fragment 204 overlaps the long-read coordinate of the upstream end of fragment 206 and the overlap is less than 50 percent of the length of either fragment 204 or fragment 206. Fragment 206 is then linked to the combination of fragments 202 and 204. With regard to fragment 208. the downstream end of fragment 206 does not overlap with the upstream end of fragment 208, but the gap between them is less than 500 bases, so that fragment 208 is linked to the linked fragments 202, 204, 206. In this manner larger fragment extensions (combined alignments) can be formed from smaller long-read fragments to cover as large spans of the long-read as possible.

### 5.7 Repeating Seed Candidate Selection and Linking to Obtain a Plurality of Linked Alignment Extensions

The linking step starts with a particular seed candidate alignment. However, the optimal linked extension may not be obtainable using the particular seed alignment selected. Therefore, the seed candidate selection (step 5) is repeated, followed by an attempt to link the other alignments in the seed group to each successively selected seed alignment (step 6). Put another way, the linking and extension, for any particular seed candidate alignment, occurs in a loop that is nested within a seed selection loop, so that iterative attempts to link and extend are made for all of the seed candidate alignments.

### 5.8 Selecting the Linked Alignment Extension with the Highest Alignment Score

In some implementations, to focus more efficiently on the longest linked extensions, any linked alignment extensions that cover less than a threshold percentage of the entire long-read are discarded. In certain embodiments, the threshold percentage is about 50% to 60%, about 60% to about 70%, about 70% to about 80%, or about 80% to about 90%. The remaining linked alignment extensions are then scored. The score of the linked alignment extensions is calculated as the sum of the scores of all of the fragments that form the extensions. The linked alignment extension with the highest combined score is determined, and this extension and all extensions having a score within 10 percent of the highest score are retained for further analysis.

### 5.9 Determining the Presence of a Novel Structural Variation in the Long-Read Data

The final output of prior steps (1 to 8) comprises either one or more linked alignment extensions (i.e., combined alignments) that cover the threshold percentage of the long-read, or, if this criterion is not met, no valid output. In the latter case, if no combined alignment can be derived, the long-read analysis does not determine the presence of a structural variation. If a single linked alignment extension remains, the number of fragments within the linked extension is first determined. If it is determined that the linked extension contains only a single fragment (i.e., no other fragments are linked, and the single fragment cover the threshold percentage of the long-read itself), in this case again, the long-read analysis does not determine whether a structural variation is present in the long-read. If, on the other hand, it is determined that the linked extension contains two or more fragments, if each of the fragments are mapped to a single locus of the reference genome, then it is determined that the combined alignment is a “split-read” which may capture one or more structural variations. However, if the combined alignment contains more than one fragment mapped to multiple loci of the reference genome, then in this case as well, the long-read analysis stops and it is not determined whether structural variations are present in the long-read.

In addition, a further cross-check can be performed. If it turns out that there are two distinct combined alignments that have mutual overlap of another set percentage of their respective bases, the long-read is discarded as any structural variation information in this case is considered ambiguous. In certain embodiments, the set percentage for discarding is about 90% to about 92%, about 92% to about 94%, about 94% to about 96%, about 96% to about 98%, or about 98% to about 100%.

### 5.10 Classifying the Structural Variation

Upon determining that a linked alignment extension is a split-read that may contain a structural variation, the analysis can proceed to classify the variation in terms of one of the known structural variation types. In performing classification, the coordinates of adjacent pairs of aligned fragments are compared. A first parameter (“sDiff”) is calculated which represents the distance between the adjacent fragments based on their reference genome coordinates. The sDiff value is greater than zero (>0) if there is a gap (measured in base pairs) between the adjacent segments, and is less than zero (<0) if the adjacent segments overlap. In addition, a second parameter (“qDiff”) is calculated which represents the distance between the adjacent fragments based on their long-read coordinates. Similarly, the qDiff value is greater than zero (>0) if there is a gap between the adjacent segments, and is less than zero (<0) if the adjacent segments overlap. Certain structural types can be determined directly based on the parameters sDiff and qDiff. For example, the following guidelines in the table below can be used for classifying insertions, deletions and indels. It is noted that the number of base pairs used as thresholds for sDiff and qDiff (e.g., 20 as indicated in the table below) can vary in different embodiments. For example, in an alternative embodiment, an insertion can be determined if sDiff <25 and qDiff >18. Likewise, in certain embodiments, the qDiff threshold is 15 to 17, 17 to 19, 19 to about 21, 21 to 23, or 23 to 25.

| Structural Variation Type | sDiff (bp) | qDiff (bp) |
|---|---|---|
| i. Insertion (INS) | <20 | >20 |
| ii. Deletion (DEL) | >20 | <20 |
| iii. Indel (INDEL) | >=20 | >=20 |

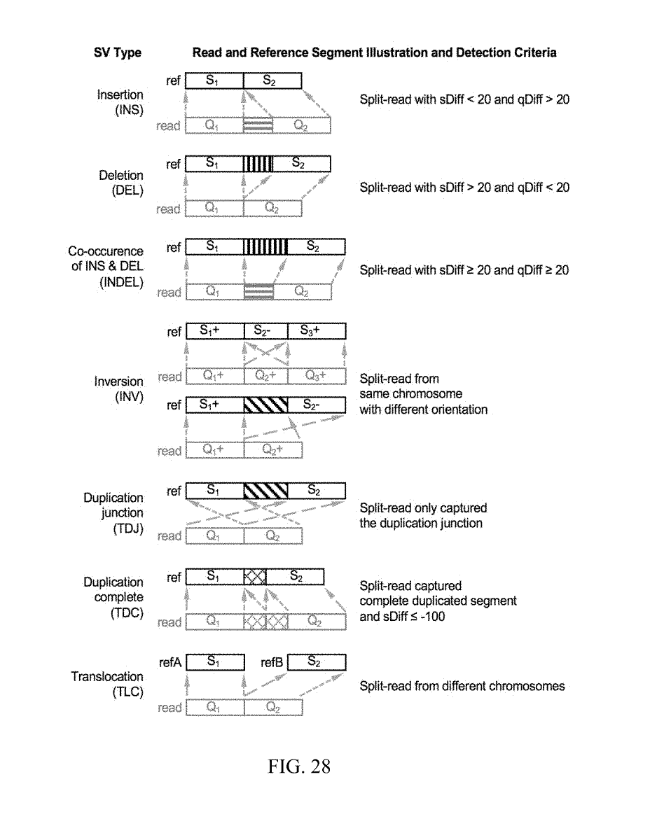

Other structural variations include (following i to iii from the table above): iv) inversions (INVs), which are classified by determining that the split-read fragments are from the same chromosome and have different orientation; v) translations (TLCs), which are classified by determining that the split-read fragments are from different chromosomes; vi) tandem duplications (TDs), which are classified by determining that the split-read fragments capture a duplication junction (TDJ) with the tail and head of a duplicated fragment; and vii) tandem duplication completes (TDCs) which are classified by determining that the split-read fragments capture a complete duplication fragment and sDiff ≤100. Further detail on assignments of split reads into seven classes of SVs is provided described elsewhere herein, see also FIG. 28.

Referring again to FIG. 2D, an example of SV classification is illustrated. As shown, the right end section of fragment 204 overlaps with the left end section of fragment 206. Given that the long-read comes from a continuous genomic sequence, an overlapping alignment between fragments and the reference genomic sequence 201 is an indication of a tandem duplication (TD) 222 outlined in the figure. A gap 224 is also shown between fragment 206 and 208. A gap in alignment with respect to the reference genomic sequence 201 is indicative of a deletion. In this manner, by aligning long-read sequences with respect to the reference genomic sequence 201, complete structural variations can be detected and classified.

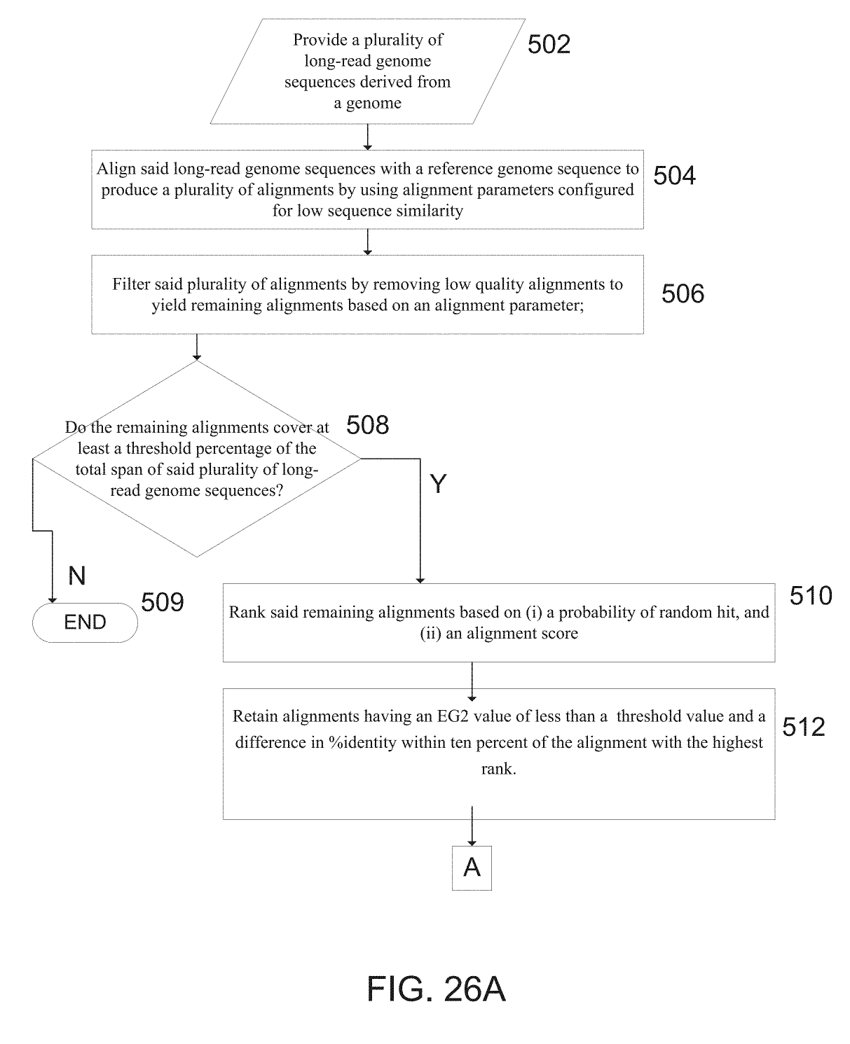

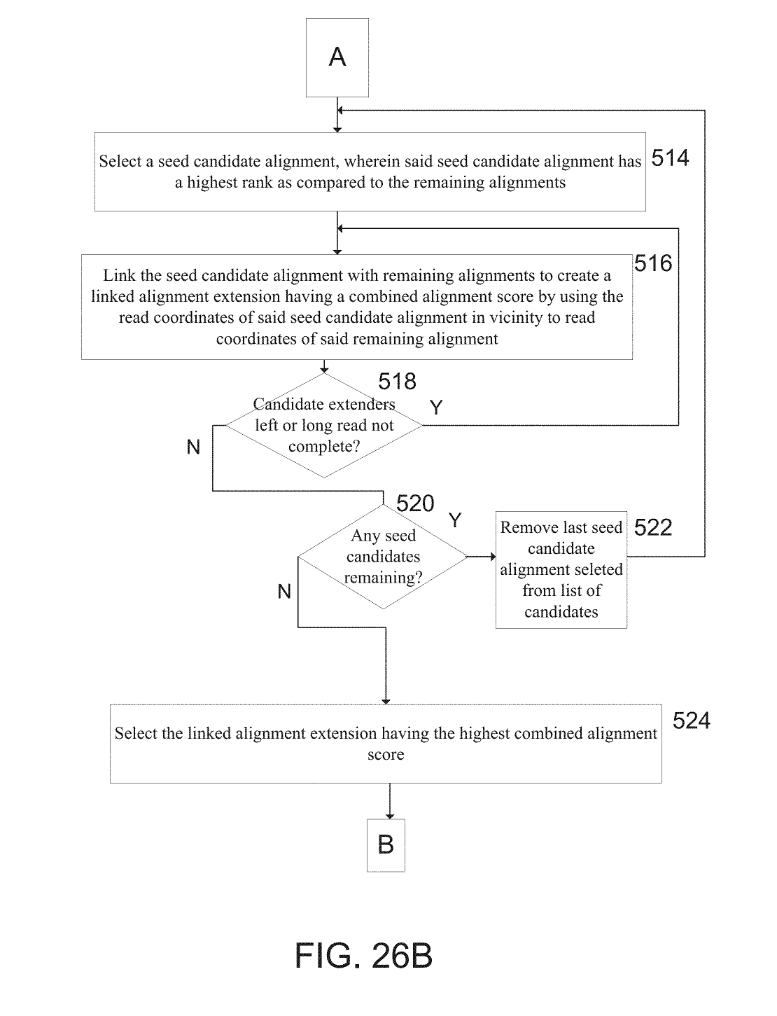

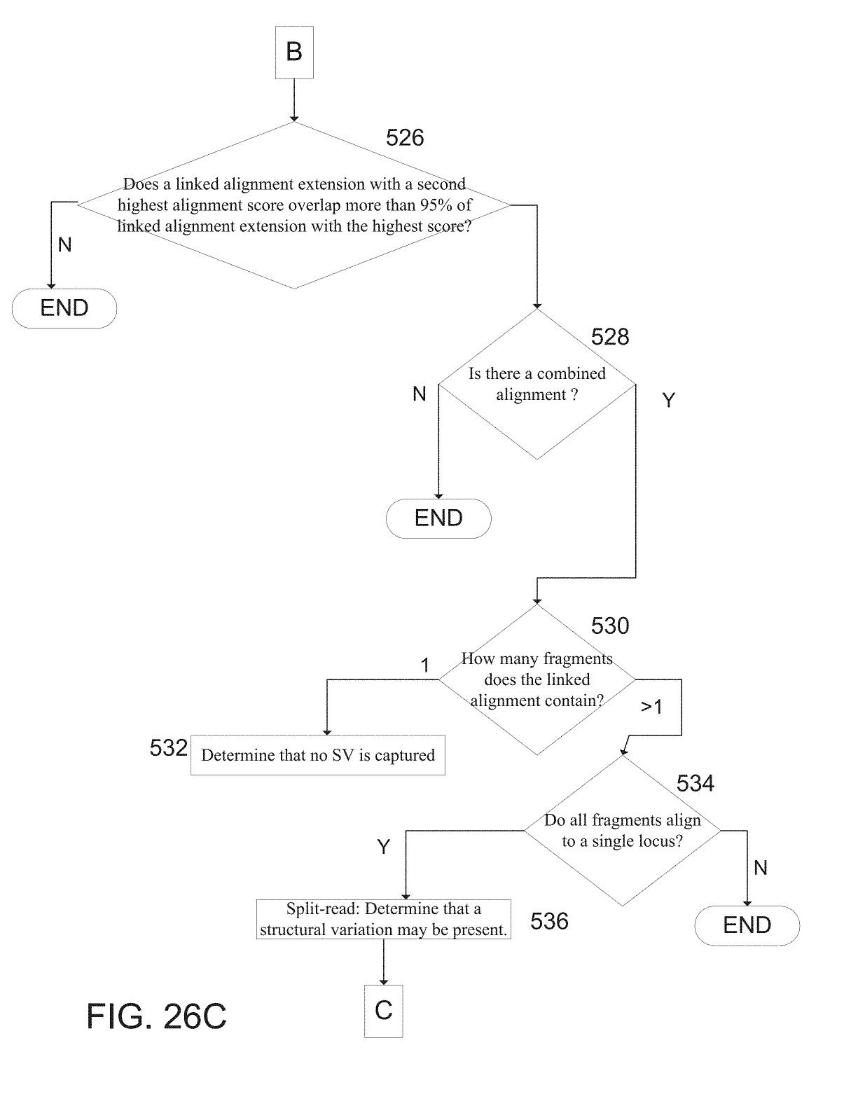

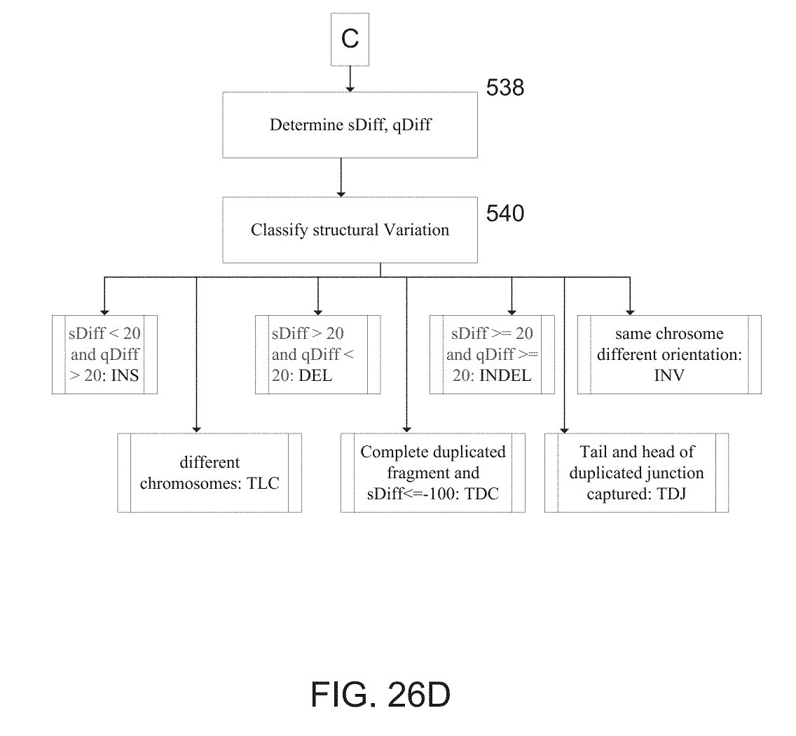

FIGS. 26A-D illustrate a flow chart of one embodiment of the method disclosed above. Referring to FIG. 26A, in an initial step 502, long read genomic data, including a plurality of long-read genome sequences, is provided for processing an analysis. In the following step 504, the long-read genome sequences are aligned to a reference genome using alignment parameters configured for low sequence similarity, producing a plurality of alignments. In step 506, the plurality of alignments are filtered by removing low quality alignments to yield remaining alignments. In a decision step 508, it is determined whether the remaining alignments cover at least a threshold percentage (e.g., in a range of about 50 to about 90 percent, as discussed above) of the total span of the long-read data. If the remaining alignments cover less than the threshold percentage of the total span (N), then in step 509 the method ends. If it is determined that the remaining alignment cover the threshold percentage of the total span of the long-read data, in step 510, the remaining alignments are ranked based on i) probability of a random hit (EG2 value), and ii) an alignment score. In the following step 512, alignments are retained that have an EG2 value below a threshold (e.g., 1e⁻⁴⁹) and a percentage identity within a set percentage of the highest ranked alignment.

The method continues in FIG. 26B. In step 514, the highest ranking alignment is selected as a seed candidate. In step 516, attempts are made to link the remaining alignments with the seed candidate based on the long-read coordinates of the seed alignment and the remaining alignments. When alignments are linked, extensions (combined alignments) are created. The linked extensions have an alignment score that is the sum of scores of their component alignments. In step 518 it is determined whether there are any further alignments (extenders) left or whether the long read has not been completed. If either of the conditions of 518 applies, the process cycles back to step 516. If either of the conditions of decision step 518 does not apply, a further decision step 520 is reached, at which it is determined whether any seed candidates remain. If so, the last seed selected is removed in step 522, and the process cycles back to step 514 at which a new seed candidate alignment is selected. The decision loops create nested cycles that enable seed candidates to be selected in turn in order to create a linked extension that maximizes the coverage of the long-read (which will have the highest combined alignment score). If there are no seed candidates remaining after step 520, the linked alignment extension having the highest combined alignment score is selected in step 524.

After step 524, the method continues in FIG. 26C. In decision step 526, it is determined whether the linked alignment extension with a second highest score overlaps more than a set percentage of the linked alignment extension with the highest score. If there is overlap above the set percentage, the method ends. If the overlap is less than the set percentage, in another decision step 528, it is determined whether a combined alignment extension has survived the previous steps. If there is no linked alignment extension, the method ends. If there is at least one combined alignment, in step 530, the number of fragments in the linked alignment extension is determined. If there is only one fragment, in step 532 it is determined that no structural variation has been captured in the long read. If, on the other hand, there are multiple fragments, in a further decision step 534 it is determined whether all of the multiple fragments align to a single locus. If the multiple fragments align to a single locus (Y) it is determined in step 536 that there is a split read tied to a single locus and that a novel structural variation may be present. Otherwise, if the multiple fragments are not aligned to a single locus, the method ends.

FIG. 26D illustrates additional processing steps after it has been determined that a novel structural variation may be present. In step 538, quantities sDiff, qDiff described above are calculated, and in step 540 the structural variation is classified in the manner discussed above with reference to sDiff, qDiff and other positional parameters.

The disclosed method is developed and executed using one more computers including terminals servers and storage devices. A computer generally includes one or more processors, computer-readable storage devices, and input/output devices. A processor may be any suitable processor such as the microprocessor. A computer-readable storage device can include any machine-readable medium or media on or in which is stored instructions (one or more software applications), data, or both. The instructions, when executed, can implement any or all of the functionality described herein. The data can be the genomic data as described herein. The term “computer-readable storage device” shall be taken to include, without limit, one or more disk drives, tape drives, memory devices (such as RAM, ROM, EPROM, etc.), optical storage devices, and/or any other non-transitory and tangible storage medium or media.

Input/output devices according to the invention may include a video display unit (e.g., a liquid crystal display (LCD) or a cathode ray tube (CRT) monitor), an alphanumeric input device (e.g., a keyboard), a cursor control device (e.g., a mouse or trackpad), a disk drive unit, a signal generation device (e.g., a speaker), a touchscreen, an accelerometer, a microphone, a cellular radio frequency antenna, and a network interface device, which can be, for example, a network interface card (NIC), Wi-Fi card, or cellular modem.

The disclosed methods utilize one or more development programming environments and databases. The databases may be accessible from the programming environment as online resources or locally stored. Any development environment, database, or language known in the art may be used to implement embodiments of the methods. Preferably, an object-oriented development language, database structure, or development environment is used. Exemplary languages, systems, and development environments include Perl, C++, Python, Ruby on Rails, JAVA, Groovy, Grails, Visual Basic .NET. In some embodiments, one or more applications have been developed in Perl (e.g., optionally using BioPerl). Object-oriented development in Perl is discussed in Tisdall, Mastering Perl for Bioinformatics, O'Reilly & Associates, Inc., Sebastopol, Calif. 2003.

### 6. EXAMPLES

### 6.1 Methods

To assess the utility of the long-read sequencing for detecting SVs, a long-read analysis was performed on the genome of the breast cancer cell line HCC118719, a model for triple-negative breast cancer (TNBC) whose genome harbors extensive structural variation that has been previously characterized at the molecular level by paired-end short-read whole genome sequencing. See Menghi, F. et al, “The tandem duplicator phenotype as a distinct genomic configuration in cancer”, Proc. Natl. Acad. Sci. USA 113, E2373-2382 (2016); Gazdar, A. F. et al. Characterization of paired tumor and non-tumor cell lines established from patients with breast cancer. Int. J. Cancer 78, 766-774 (1998). A comparison of the results of long-read sequencing analysis was made to this previously generated data set. Long-read sequencing libraries were prepared from fragmented high-molecular-weight genomic DNA and subjected to sequencing.

Long-Read Sequencing:

High molecular weight DNA was extracted from HCC1187 cells by MagAttract HMW DNA Kit (Qiagen, 67563) following the manufacturer's instructions. Briefly, 1×10⁶ frozen cells were lysed with 220 μL of Buffer ATL, 20 μL Proteinase K and incubated overnight at 56° C. with 900 rpm. 4 μL RNase A was added to cleave RNA. 150 μL Buffer AL, 280 μL Buffer MB and 40 μL MagAttract Suspension G beads were then added to capture the HMW DNA. Next, the beads were cleaned up by 700 μL Buffer MW1, Buffer PE and NFW followed by elution with 150 μL Buffer AE.

Long-read sequencing libraries were prepared according to the target size and the sequencing kits supplied by Oxford Nanopore Technologies (ONT). Human molecular weight genomic DNA was fragmented by one of miniTUBE Blue (Covaris, 520065, for 3 Kb), miniTUBE Red (Covaris, 520066, for 5 Kb) or g-TUBE (Covaris, 520079, for 8 Kb and 12 Kb). For libraries targeted at 12 Kb, size selection was performed for sheared fragments larger than 10 Kb using a 0.75% agarose cassette (Sage Science, BLF7510) by the Blue Pippin™ DNA Size Selection System. For libraries of less than 10 Kb, AMPure XP beads (Beckman Coulter, A63881) were used for clean-up. Next, libraries were prepared according to recommendations of ONT.

Briefly, NEBNext FFPE RepairMix (NEB, M6630) was added to repair nicks in the DNA. Then end-repair and dA-tailing were performed using NEBNext Ultra II End-Repair/dA-tailing Module (NEB, E7546). For 2D libraries (WTD01-WTD13), a ligation reaction was prepared as follows: 38 μL water (DNA), 10 μL Adapter Mix (AMX), 2 μL Hairpin Adapter (HPA) and 50 μL Blunt/TA Ligase Master Mix (New England Biolabs, M0367). Ligation was performed at room temperature for 15 minutes. A 1 μL Hairpin Tether (HPT) was added to the reaction and incubated at room temperature for 15 minutes. Then 50 μL MyOne C1 beads (Thermo Fisher, 65001) beads were prewashed twice with 100 μL Bead Binding Buffer (BBB). The MyOne C1 beads resuspended in 100 μL BBB were added to the ligated DNA reaction and incubated on a rotator at room temperature for 15 minutes. The beads were washed twice with 150 μL BBB and eluted in 25 μL Elution Buffer (ELB). For 1D libraries (WTD14-WTD15), the ligation reaction was prepared as follows: 30 μL water (DNA), 20 μL Adapter Mix (AMX) and 50 μL Blunt/TA Ligase Master Mix (New England Biolabs, M0367). Ligation was also performed at room temperature for 15 minutes. The AMPure XP beads were resuspended at room temperature by vortex. 40 μL of beads were added into the ligation product. The beads were washed twice with 140 μL Aldapter Bead Binding (ABB) buffer and eluted in 25 μL Elution Buffer (ELB). The eluted product was the adaptor-ligated library as the Pre-sequencing Mix (PSM) used in nanopore sequencing.

The libraries were sequenced on MinION Mk1b device using R9 and R9.4 flow cells following the standard 48 h run scripts. Real-time basecalling was performed on EPI2ME cloud platform (ONT). Read sequences were extracted from base-called fastf5 files by Poretools (version 0.5.1) to generate a fastq file. All 2D reads from WTD01-13 (2D ligation libraries) and all 1D reads from WTD14 and WTD15 (1D ligation libraries) were used for subsequent analysis.

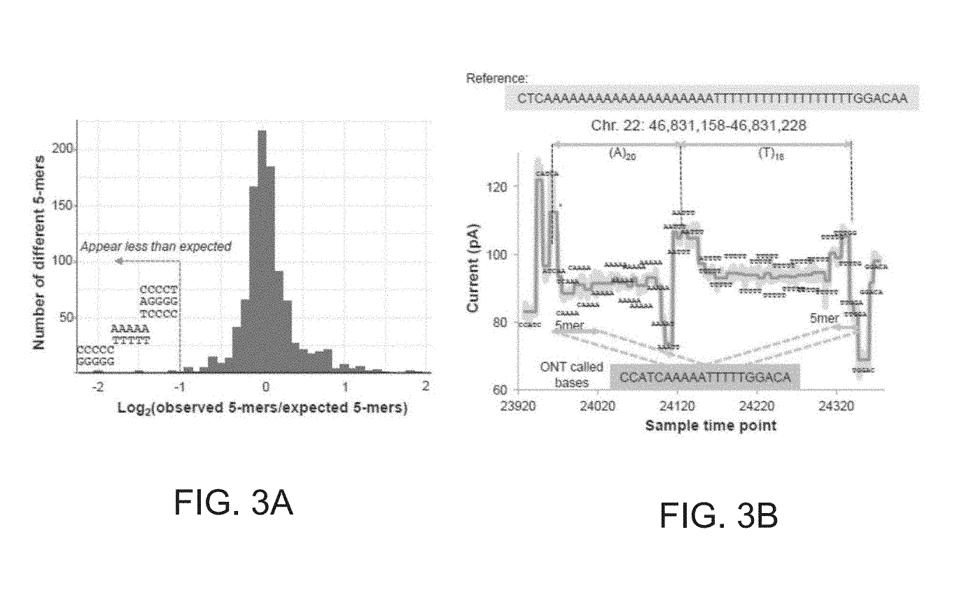

In one set of test experiments, the above-described long-read computational analysis pipeline was applied to 796,029 2D reads to detect and classify SVs in the HCC1187 genome (FIG. 3a). From 53,701 split reads, a total of 34,100 unique SVs and their corresponding 66,660 breakpoints were determined. The SVs were classified into 220 inversions, 1,911 translocations, 3,567 tandem duplications and 28,402 insertions, deletions and indels.

In addition, DNA templates were prepared as described in 12 Kb nanopore sequencing libraries. A PacBio genomic DNA library was prepared (12 Kb) according to the manufacturer's instructions (Greater Than 10 Kb Template Preparation Protocol). The library was sequenced on PacBio RS II instrument. PacBio sequencing data was processed by the PacBio SMRT Portal pipeline of Read of Insert with the parameters “min full pass=0” and “min predicted accuracy=75”.

Pipeline for SV Detection:

The long-reads were processed according to the long-read analysis method disclosed above. Firstly, the nanopore long-reads were mapped to human genome (hg19) using the LAST aligner (last755) with the parameters “−r1−q1−a0−b2” set to 1 (reward), −1 (penalty), 0 (gap cost (open)) and 0 (gap extension cost) for high sensitivity. See Stephens, P. J. et al. “Complex landscapes of somatic rearrangement in human breast cancer genomes”, Nature 462, 1005-1010 (2009). The LAST aligner reported all high scoring pair (HSP) fragments for each nanopore read. Next, fragments with EG2>1.74743e−¹² or % Identity <55 were discarded. Nanopore reads with no aligned fragments post-filtering were considered unmapped and reads with only a single segment were reported as uniquely mapped. For read with multiple fragments, the best fragment (lowest EG2 and highest score) was used to determine the EG2 threshold (EG2best) and % identity (% identitybest). Fragments which EG2<1e⁴⁹ and the absolute difference between alignment % identity and % identitybest <=10% were retained.

To speed up processing, fragments were grouped into representative subgroups, namely ‘exact’, ‘subset’, ‘similar’. Fragments in subgroup ‘exact’ share the exact read start and end coordinates although their genomic coordinates differ. Subgroup ‘subset’ contains fragments having read coordinates that are a sub-span of the representative fragment for the subgroup. Members of subgroup ‘similar’ have 95% reciprocal overlap and % identity difference <=5 with respect to the group's representative fragment. A greedy seed-and-extend strategy was used to stitch (link) fragments together and produce the linked alignment extensions that span as much of the nanopore read as possible. The fragments for which EG2=EG2best were designated as the seeds. If there were >=5 seeds, the top 200 of them were used as potential extenders. Otherwise, potential extenders could consist of the fragments group(s) where EG2=0 minimally, with the successive inclusion of the 4 fragment group collections binned by 0<EG2<=1e⁻³⁰⁰, 1e⁻³⁰⁰<EG2<=1e⁻²⁰⁰, 1e⁻²⁰⁰<EG2<=1e⁻¹⁰⁰, and 1e⁻¹⁰⁰<EG2<=1e⁻⁵⁰, with the total number of extenders capped at 100.

The seed and extension process began with selection of a seed candidate and attempts were made to extend the seed candidate with the potential extenders to maximize the coverage of the entire nanopore read. The criteria for an extender to be selected was that it extend the current read coverage by at least 200 bases and that the overlap between the extender and current combined fragments account for <50% of each length. This process then continued until the entire nanopore long read was covered or there were no remaining extender candidates. The linked alignments (the permutation of 5′ extensions, seed and 3′ extensions) were then scored as the sum of their component fragment score. Combined alignments that did not cover more than 70% of the read were discarded. All combined alignments with score within 90% of the best score for a nanopore read were reported.

In cases in which there were no alignment extensions, the long-read read was classified as “without candidate”. If multiple combined alignments remained, it was classified as a multi-candidates read. When only a single combined alignment remained, it was classified as either a single high scoring pair (Single Combined, Single Fragment(SCSF)), or multiple high scoring pairs (Single Combined, Multiple Fragments (SCMF)). SCMF reads were used to capture potential structural variations. Structural variation determination was performed on SCMF where each high scoring pair fragment mapped to a single locus (SCMF-single locus (SCMFSL)), also known as a split read. SCMFs with fragments mapping to multi-loci (SCMF-multiple loci (SCMFML)) were ignored. Finally, SV determination was performed based on the order and the distance between aligned fragments of the SCMF, using sDiff and qDiff as described above.

Methods of the invention included the assignment of split reads into seven classes of SVs: inversion (INV), or segments aligned to the same chromosome but in different orientations; translocation (TLC), or segments aligned to different chromosomes; tandem duplication (TD), which included segments containing a complete duplicated region (TCD) as well as those only spanning a duplication junction (TDJ); simple insertion (INS) or deletion (DEL), or segments corresponding to the same chromosomal region in the same orientation but either flanking a sequence that does not match the reference genome or lacking an intervening sequence observed in the reference genome, respectively; and INDELs, segments indicating both INS and DEL for the same split read. FIG. 28 illustrates the logic and criteria used to define seven SV types using methods of the invention.

A correction method was also employed to reduce the impact of the high nanopore error rate in homopolymer sequences on SV detection. Specifically, homopolymers in all four nucleotide contexts (Aₙ, Tₙ, Cₙ and Gₙ) were significantly underrepresented relative to expectation. FIG. 3A is a histogram showing the ratio of the observed versus expected instances of all 1,024 5-mers. The 4 under-detected homopolymers are highlighted. Examining the raw signal data and their corresponding base identifications, it was concluded that homopolymers beyond five identical bases are not correctly reported and lead to false-positive classification as deletions as shown in FIG. 3B which is an annotated current trace for the segment harboring base-called deletion. The current trace indicates the clear presence of the two homopolymers (marked (A)20 and (T)18) rather than the deletion flanked by (A)5 and (T)5. Therefore, deletions found in the homopolymer regions were ignored. As a result of this adjustment, the numbers of SVs classified as insertions, deletions or INDEL decreased from 29,977 to 28,402.

Comparison Between Long- and Short-Read Data:

In a comparison between long-read data and short-read data, the nanopore reads (long-reads) that aligned uniquely (with possible multiple fragments) to the human genome (hg19) were extracted for genome coverage computation with BedTools (v2.25.01). Similarly, HCC1187 Illumina paired-end sequencing data (SRA accession SRX969058) was mapped to human genome with BWA-MEM (v0.7.12). The mapped reads were sampled at 2.5×, 10×, 30× and 60×. Genome coverage was computed on reads with a mapping quality of 60. For the comparison of long-read with short-read SV calls, SVs from long reads and short reads were deemed overlapping if (1) their genomic spans overlapped and (2) the ration of the larger SV length to the smaller SV length did not exceed 3. Density plots were generated from the specific SV spans.

NA12878 Nanopore Data SV Comparison.

A12878 nanopore reads were downloaded. NanoSV was used to call SVs (set N) with the parameter “−c 2” on LAST alignment. LAST alignments were generated on the basis of previously established last-train scoring parameters. Sniffles was used to call SVs (set S) with the parameters “−n−1 −s 2” on NGMLR alignments. Methods of the invention were used to call SVs (set P) on LAST alignment generated with the parameters “−C2 −K2 −r1 −q3 −a2 −b1.” All alignments were done against the human reference genome hg19. The insertions and deletions identified by the PacBio long-read data from the same genome were used as the reference call set (set R). Only SVs with length >30 bases were used for comparison. To determine the overlap between SV set X and Y, the number of SV calls x that overlapped SV call y, and the number of SV calls y that overlapped SV call x were counted. SV calls x and y were deemed overlapping if their genomic spans overlapped and the ratio of the larger SV length to the smaller SV length did not exceed 3. To determine the sensitivity of deletion calling, the overlap calculations were repeated with the required minimum read support enumerated from 2 to 20.

Phased Adjacent SVs from Multi-Breakpoint Long Reads.

Additionally, pairs of adjacent SVs determined to be present were counted in all long-reads having multiple breakpoints under the assumption that the expected count would follow the distribution of independently drawing two SVs from the population of the SVs from all the multi-breakpoint long reads. The log-likelihood was then computed.

SV Span-Size Distribution.

To explore the genomic features of the SVs found, different methods were used to ascertain the distributions of their span size. For DEL, INS and INDEL, the total numbers of SVs from each genomic bin (bin size=20 bp) were calculated. For INDELs, sDiff and qDiff were used as deletion and insertion spans, respectively. For TDC, TDJ and INV, density plots were generated from their span distributions to show their large size variations.

Genomic Distribution of SVs and Breakpoints.

Breakpoint density was computed from the numbers of breakpoints per Mb across the genome. The density of translocation pairs was calculated using the translocation breakpoint distribution in pair per Mb across the genome. A Circos plot was performed using the breakpoint densities, spans of TDC, TDSR (<20 Mb), INV and TLC pairs (counts >3).

Association Between Gene Coding and Breakpoint Density.

Gene density was computed as the fraction of bases overlapping with annotated gene regions (exons and introns; GenCode V24) in each Mb bin across the genome. Violin plots of the gene density from the top 10% breakpoint dense regions (breakpoint density >40) and the bottom 10% least dense regions (breakpoint density <9) were generated. A Mann-Whitney test was performed.

Breakpoint Landscape Analysis.

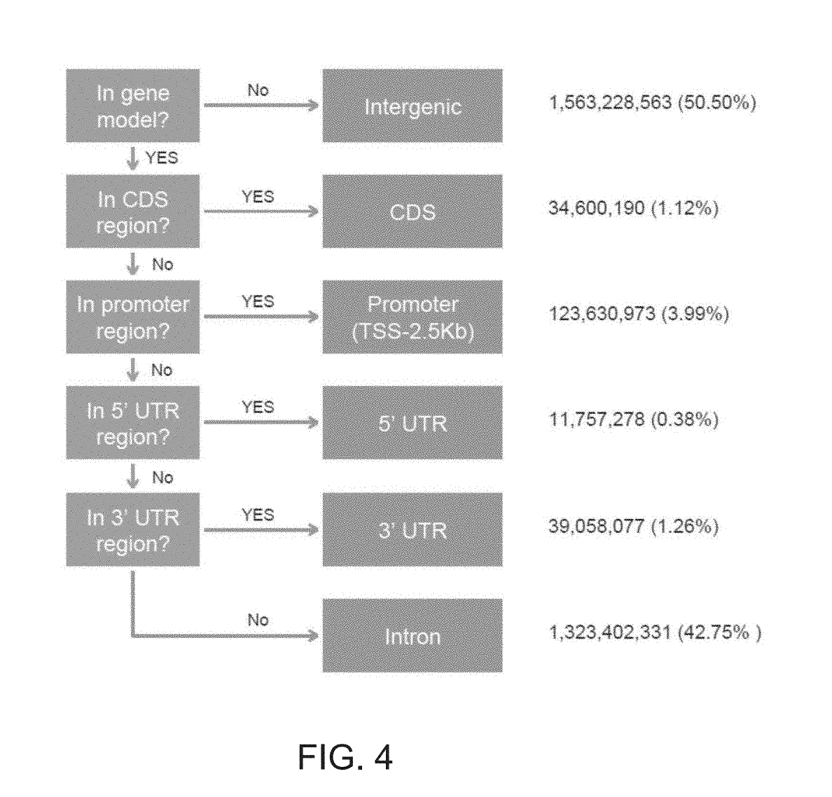

Each breakpoint was stepwise assigned to different class of genomic features based on the GENCODE v24 gene model. FIG. 4 is a schematic flow diagram, which depicts an exemplary process of assigning breakpoints to their corresponding genomic features based on the gene model. The promoter was defined as the upstream 2.5 Kb region of the transcription start site. The fraction of reference genome in each class was taken as the background distribution to compute the expected number of breakpoints for each SV type. For SVs with two breakpoints, the pair was considered independent. The ratio of number of breakpoints between observed and expected was log 2 transformed.

Repeat Analysis.

To determine whether the inserted DNA fragments from INS and INDEL as well as TD regions contained repetitive sequences, and if so, which class of repeats, inserted or duplicated DNA sequences were extracted from their corresponding nanopore long-reads and allocated to different repeat classes by aligning them to public annotated repeat sequences using RepeatMasker-open-4-0-6 (http://www.repeatmasker.org/). A violin plot was generated with the percentages of the SV fragments annotated to repeats (hg19). The relative ratios of the most predominant repeat class, all other repeats and no repeat from each of the five SV types (TDC, deletion regions in INDEL, insertion regions in INDEL, DEL and INS) were produced in 20 bp span size intervals.

Distribution of Genomic Micro-Insertions.

Unaligned DNA sequences found between each breakpoint junction (nanopore long-reads having alignments with qDiff >20) were extracted from their corresponding nanopore reads from INDEL, TD, TLC and INV. The size distribution of the unaligned sequences was plotted for these four classes.

ICP Analysis.

“ICP” was defined as the sum of a region's inter-chromosomal contact frequencies divided by its total contact frequencies. The TCC (Tethered Conformation Capture) interaction matrix was downloaded from NCBI SRA accession SRX030110 (see Branco, M. R. & Pombo, A., “Intermingling of chromosome territories in interphase suggests role in translocations and transcription-dependent associations”, PLoS Biol. 4, e138 (2006). The ICP was then computer on the entire genome. See Howarth, K. D. et al., “Array painting reveals a high frequency of balanced translocations in breast cancer cell lines that break in cancer-relevant genes.” Oncogene 27, 3345-3359 (2008). The counts of breakpoints were partitioned into four groups from low to high. The correlation was plotted from ICPs found in different partitions.

Multidimensional Scaling of Gene Expression Analysis.

Tests were also conducted to determine and analyze the multidimensional scaling of gene expression. Structural variations with spans range from 1 Kb to 1 Mb were selected to compare their impacts on gene expressions between Triple Negative Breast Cancer (TNBC) and non-TNBC samples. There are 1,260 coding and 711 non-coding genes in the selected 537 DEL, 2,383 INDEL and 188 TDJ events (SV-genes). Their expression in 113 TNBC and 851 non-TNBC samples was retrieved from gene expression data of the breast carcinoma (BRCA) of the cancer genome atlas (TCGA) based on a previous study. See Tjong, H. et al., “Population-based 3D genome structure analysis reveals driving forces in spatial genome organization.”, Proc. Natl. Acad. Sci. USA 113, E1663-1672 (2016). Two data sets, the control set and the permutation set, were used to evaluate the significance of grouping analysis. The control data was selected from the non-SV genes of equivalent number that were expressed at similar level as the SV-genes. For the permutation data, the expressions of SV-genes were permutated sample-wise to ensure that each gene had the same expression profile with a distinct sample order. Multi-dimensional Scaling (MDS) was used to analyze the expression of SV-genes in the BRCA dataset and visualize the sample relationship.

Validation of SV Candidates.

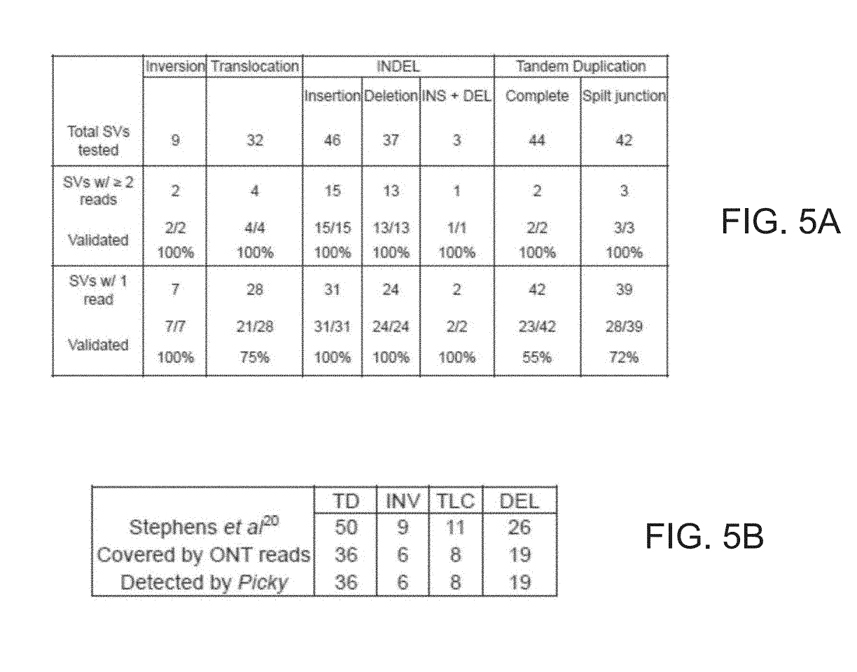

To validate SV candidates, 3-46 structural variation events from each SV classification were selected. FIG. 5A is a tabulated summary of the validated structural variations by PCR. FIG. 5B is a table showing numbers of high confidence SVs previously described in HCC1187 detected by nanopore sequencing. For candidates in DEL, INDEL, INV, TLC and TDJ, classification, primers were designed to detect the breakpoints. For candidates in INS, primers were designed to amplify the entire inserted fragments. For candidates in TDC, the validation of the breakpoints on 13 candidates and validation of the entire duplicated regions on 35 candidates was attempted.

In detail, for INVs, TLCs, and TDJs, the validation was done by PCR across the breakpoint junctions, and candidate SVs in these classes were selected mainly on the basis of (1) the presence of sequence-specific PCR primers on each side of the breakpoint and (2) amplicon sizes ranging from 0.3 kb to 1 kb. For INS, DEL, and TDC validation, entire SV regions were amplified. SV candidates that allowed for PCR primers designed in the non-repeat regions surrounding the SV junctions and enabled amplicon sizes in the range of 0.3-1 kb (DEL), 0.3-5 kb (INS), and 0.2-2.1 kb (TDC) were chosen. To minimize the confounding effect of micro-insertions in PCR primer design and amplicon size confirmation, only SV candidates that contained <50-bp micro-inserted sequences were selected for PCR validation. The presence of micro-inserted sequences was validated separately by PCR followed by sequencing to obtain nucleotide-resolution sequence information.

Checking Short-Read-Called SVs Against PCR-Validated SVs.

As an additional check against short-read structural variation identification and PCR-validated SVs, HCC1187 Illumina paired-end sequencing data (SRA accession SRX969058) was mapped to human genome (hg19) with BWA-MEM (v0.7.12). The mapped reads were also sampled at 2.5×, 10×, 30× and 60×. LUMPY (v0.2.13) was used to call SVs using both non-redundant split-read and discordant paired-end reads with the minimum weight for a call (−mw) as 2, 3, 5, 10, and 16 for the subsampled sets 2.5×, 10×, 30×, and 60× and the whole dataset (102×) respectively. The LUMPY generated vcf files were loaded in an IGV browser to visual check the PCR validated SVs locus for the same SV type called by LUMPY.

### 6.2 Experimental Results

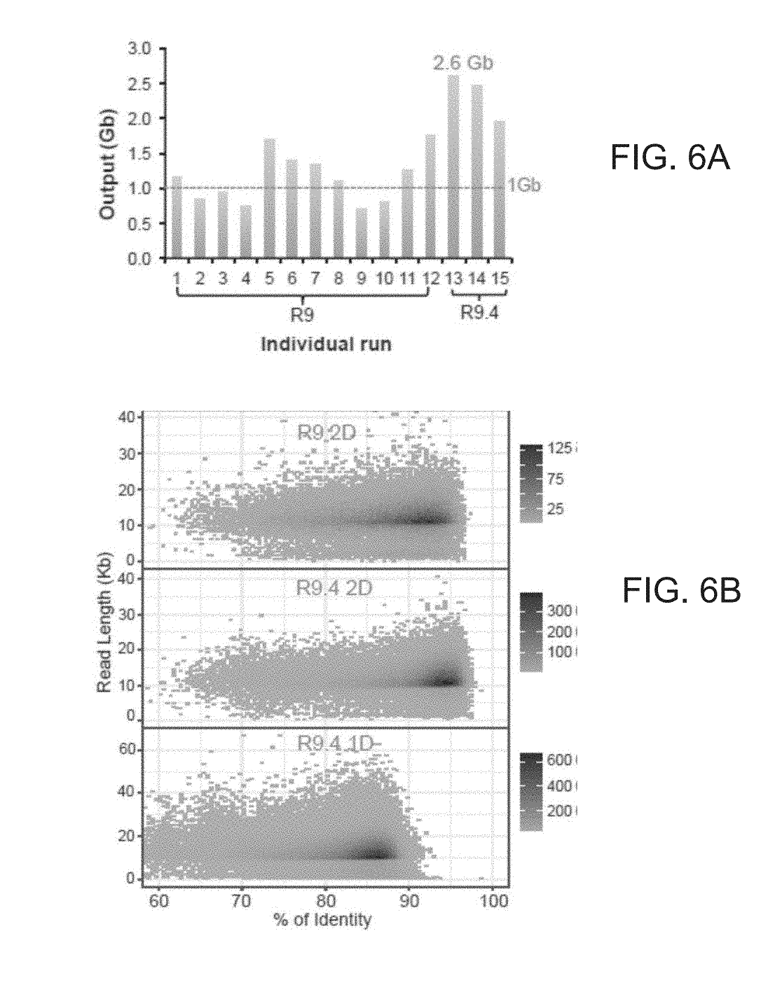

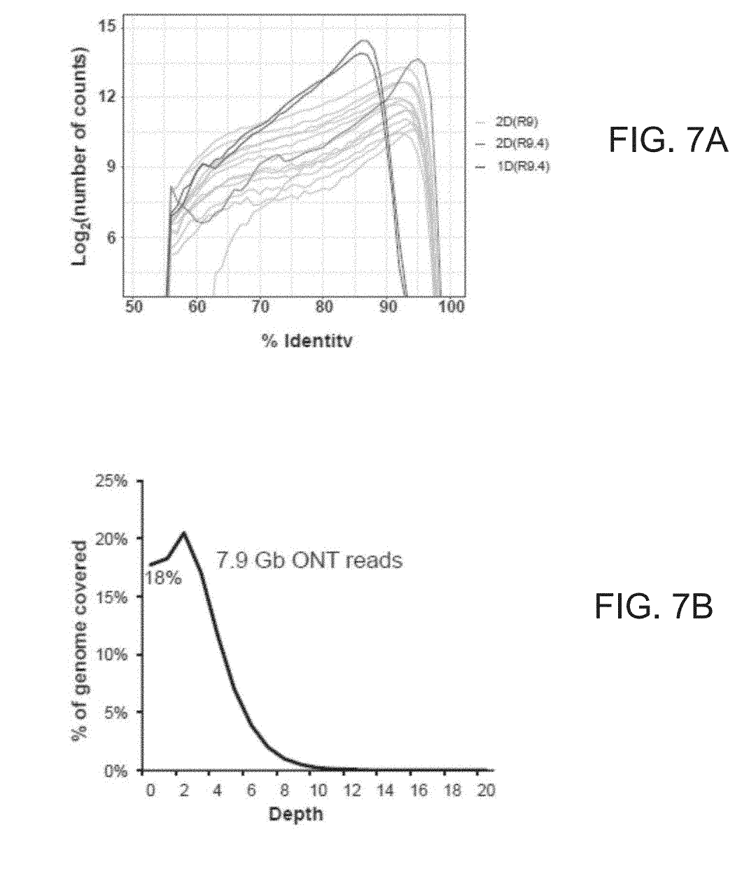

Sequencing of the single strand templates of the DNA fragments was performed to generate 1D data sets, while sequencing of both the template and complement strands, enabled through their covalent bridging by a hairpin adaptor, was performed to generate 2D data sets (FIG. 1). The 2D data sets improve sequence accuracy by aligning the template and complement sequences and resolving any ambiguous base calls between them in the final read output. Using the R9 and R9.4 MinION-compatible chemistries, sequencing speeds of 250-450 bases/sec were attained. Although substantial variations in flow cell quality were observed, significant improvement in total yield was associated with increasing sequencing speed. FIG. 6A is a histogram showing the yield of 15 nanopore long-reads of different chemistries. These sequences were aligned onto the reference genome assembly using the genome alignment tool LAST and the alignment quality was used to assess the degree of accuracy and identify base-calling errors for the different protocols and chemistries. The accuracy of the 2D reads was on average higher (94%) than that of the 1D reads (86%). Over 70% of the reads from the R9.4 chemistry aligned to reference genome with ≥90% identity compared to only 21% from the R9 chemistry (FIG. 1b). FIG. 6B is a set of three graphs of read length versus percentage identity that shows the accuracy of nanopore reads from different versions of chemistries and run protocols. The percentages of identity among different read length distribution were shown for 2D reads in R9 (250 bases/sec), R9.4 (250 bases/sec) and 1D read (R9.4, 450 bases/sec). Based on this data, 2D reads were used for subsequent analyses. FIG. 7A is a graph of log of read counts versus percentage identity which indicates that accuracy and read counts from runs with different run protocols and pore speeds. Grey, 2D and R9 (250 bases/sec). Red, 2D and R9.4 (250 bases/sec). Blue, 1D and R9.4 (450 bases/sec). From 7.9 Gb of the aligned sequence data, 2.5× average genome coverage was obtained (based on a haploid genome size) as shown in FIG. 7B which is a graph showing genome coverage versus depth from the 7.9 Gb of the nanopore data generated.

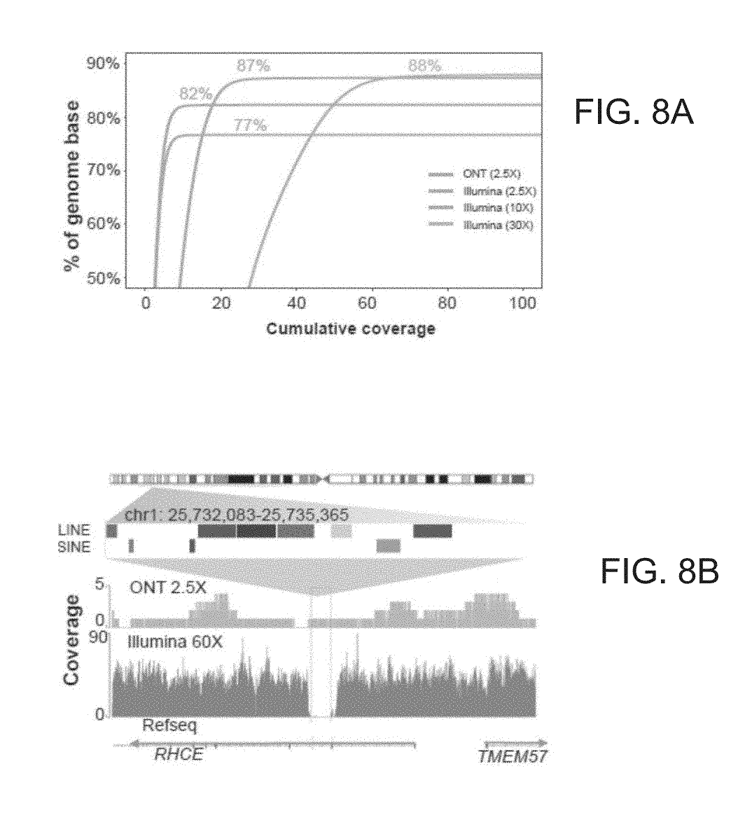

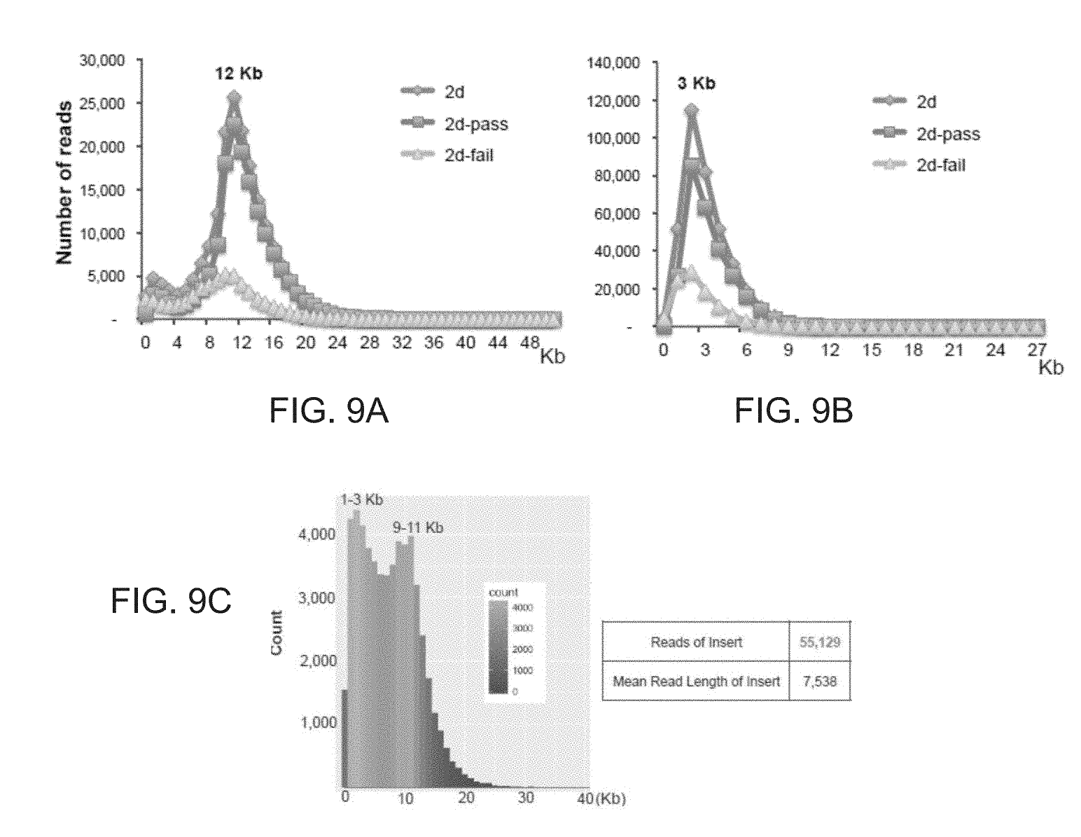

Compared to paired-end short reads at equivalent sequencing depth, long read data extended further into repetitive sequence regions of the genome and covered more of the genome (82% vs. 77%). FIG. 8A shows a graph of the percentage of the genome covered by short versus long read data of different depths. For example, a 14.7-Kb nanopore read extended into a region that is rich in short interspersed nuclear elements/long interspersed nuclear elements (SINEs/LINEs) (chr1: 25,732,083-25,747,923), a gap in the coverage of an ultra-high depth (185 Gb, 60×) of short-read data as indicated in FIG. 8B which o a chrosomal region (chr1: 25,732,083-25,735,365) covered by a 14.7-Kb nanopore read and by185 Gb, 60× of short-read data. As shown, this chromosomal region is rich in SINEs/LINEs. To determine if nanopore sequencing has any obvious length bias, DNA templates of different sizes (3-4 Kb and 12 Kb) were sequenced. It was found that the resulting read length distributions matched well with the input DNA fragment sizes and the total amounts of bases sequenced were equivalent. FIGS. 9A and 9B are graphs showing length distribution of nanopore reads from 12 Kb target template size and from 3 Kb target template size, respectively, which are also shown below.

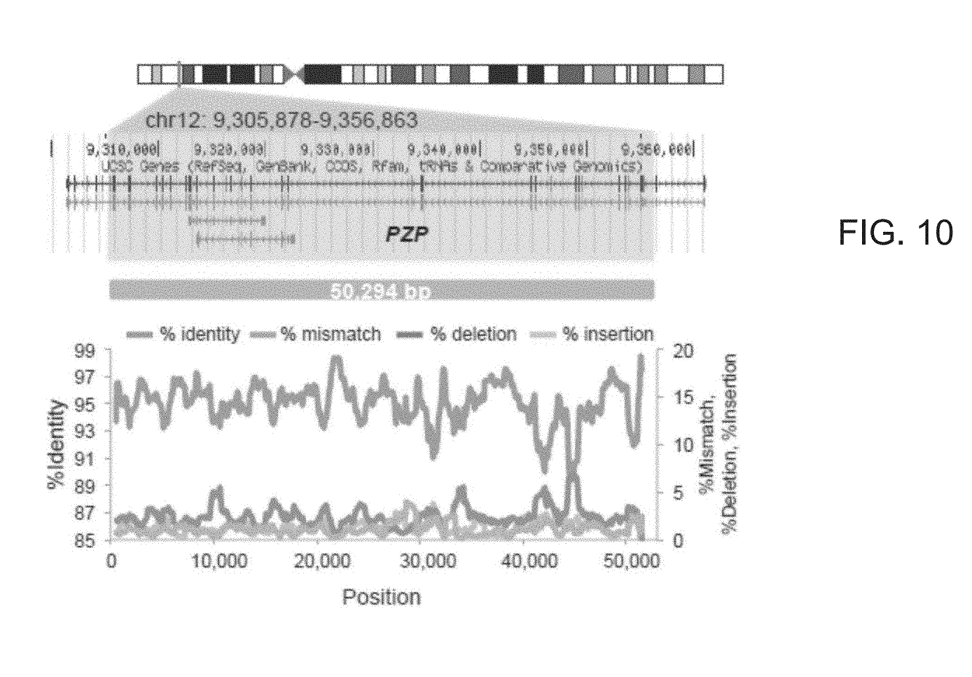

When compared with the read length distribution from the established PacBio SMRT long-read sequencing platform, using identical preparation of 12 Kb DNA templates, nanopore exhibited less bias in read length, as indicated in FIG. 9C which shows e length distribution of PacBio reads from the same 12 Kb target template size. One of the longest 2D reads we obtained was 50 Kb (i.e. totaling over 100 Kb for sequencing template and complement strands). This read aligned to the PZP gene region (chr12: 9,305,878-9,356,863) at an average of 95% identity, suggesting that nanopore is capable of generating read length beyond 100 Kb. FIG. 10 shows a 50 Kb nanopore 2D read aligned to reference human genome (chr12: 9,305,878-9,356,863) with 95% average identity. Taken together, the ability to generate long reads at gigabase output with high accuracy indicates that nanopore sequencing can be adopted to effectively analyze structural variation in cancer genomes.

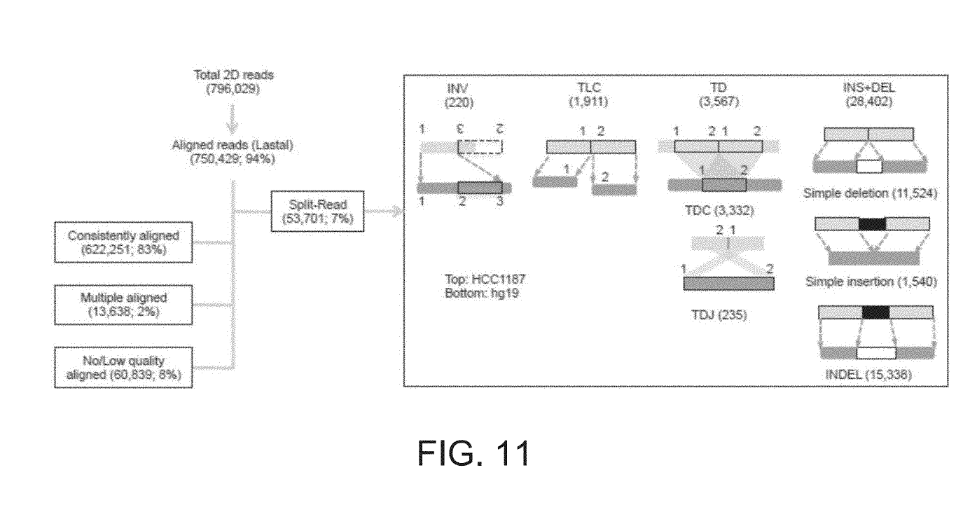

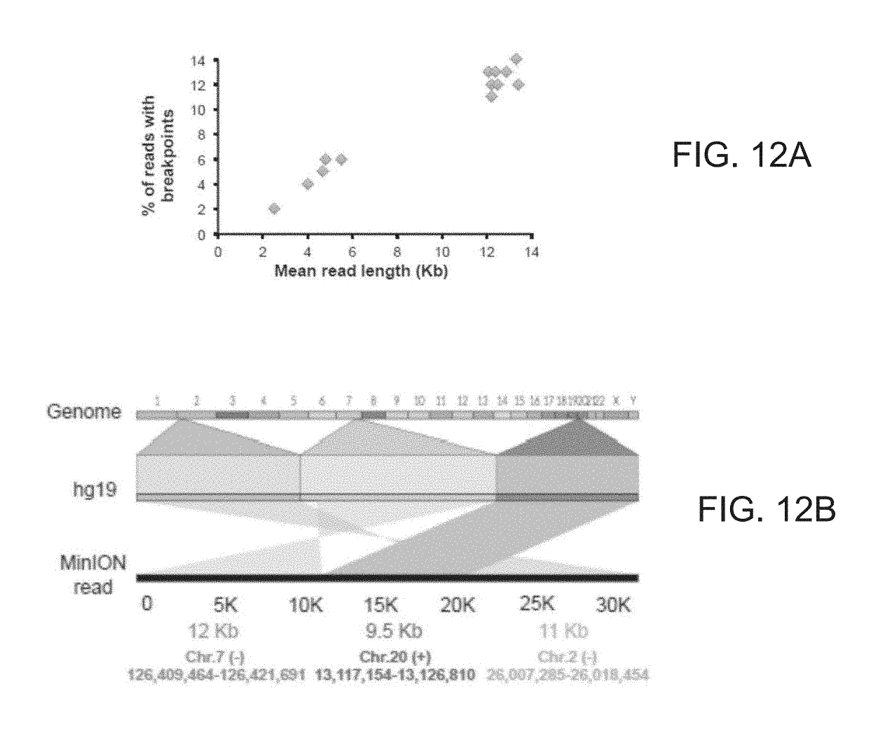

The SV determination method described above was applied to 796,029 2-dimensional long-reads to detect and classify SVs in the HCC1187 genome. FIG. 11 is a read alignment summary including different classes of SVs detected by the long read SV determination method disclosed herein. From this long-read data, 53,701 split reads were found, and from these split-reads, a total of 34,100 unique SVs and their corresponding 66,660 breakpoints, respectively, were detected. The 34,100 unique SVs were classified as 220 inversions, 1,911 translocations, 3,567 tandem duplications and 28,402 insertions, deletions and indels. Consistent with the notion that longer reads are more likely to capture breakpoints and SVs, the percentage of reads containing breakpoints (i.e. split reads) positively correlated with DNA read lengths, from 2-6% in 2.5-5.5 Kb reads to 13-14% in 12 Kb reads. The percentage of reads containing breakpoints over a span of read lengths is shown in FIG. 12A. Furthermore, 4% (2,177 of 53,701) of the split reads contained more than two breakpoints, which indicates the presence of multiple SVs on the same chromosomes. This phasing information is uniquely provided by long read sequencing.

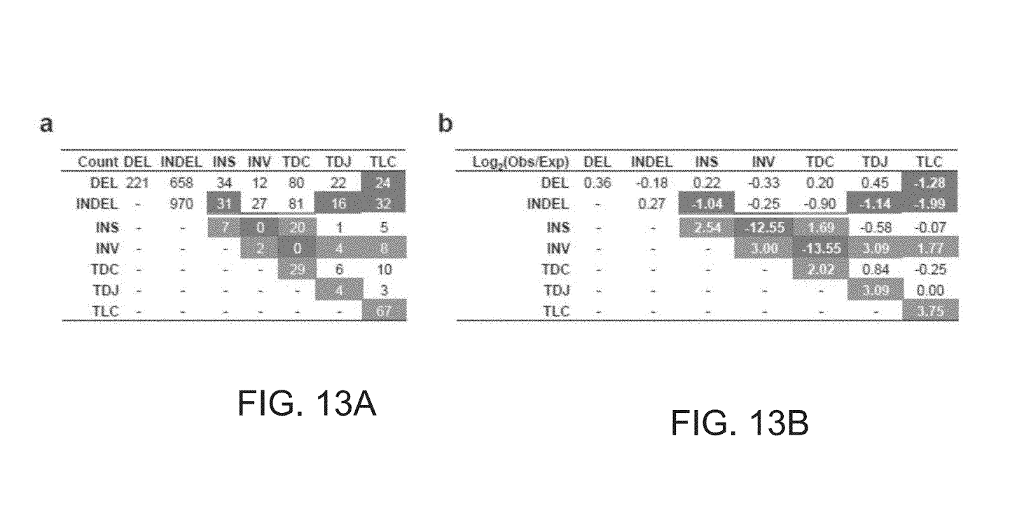

As an example, a specific nanopore read of 32.5 Kb included three consecutive segments of 12, 9.5 and 11 Kb that each aligned to a different chromosome (chromosome 7, 20 and 2) with high identity (>97%). FIG. 12B is an illustration of a structural variation composed of two translocations detected from a 32.5 Kb nanopore read. This read captured two translocations that fused the 5′ exons of GRM8 to the introns from SPTLC3 and ASXL2, which resulted in a non-functional transcript. Through examination of adjacent SVs for phasing information via multiple breakpoints within long reads, 67 co-occurring translocations (TLC-TLC), representing an enrichment of 3.09 (obs/exp) over the background were detected. FIGS. 13A and 13B are tables of the total counts (FIG. A) the log-likelihood (FIG. B) of the adjacent SVs phased by the multi-breakpoint long reads. The red count indicates observation >2× expected, while the blue count indicates observation <0.5× expected. Interestingly, 37% of dual-translocation events (25 of 67) were reciprocal (i.e. chromosome A-B-A), suggesting that double-crossovers between two non-homologous chromosomes could be a common mode of translocation. In light of the results, the long-read SV determination method as disclosed herein proved capable of resolving complex chromosomal rearrangements and delineating haplotype specific SVs.

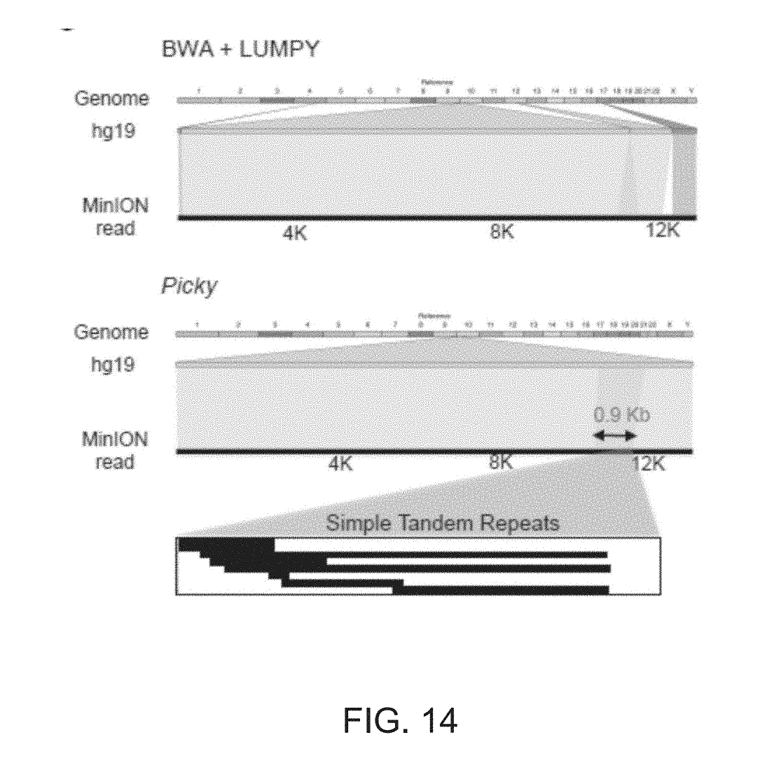

In contrast to short read SV detection tools such as LUMPY, which assumes no more than two uniquely mapped segments and one breakpoint per split read (see Frith, M. C., Hamada, M. & Horton, P., “Parameters for accurate genome alignment”, BMC Bioinformatics 11, 80 (2010)), the long-read SV determination method disclosed herein incorporates an algorithmic rationale to interpret long reads spanning multiple breakpoints that can encompass the entire structural variation. Therefore, the long-read analysis method has sufficient sensitivity to capture small SVs, particularly short tandem duplications. For example, a 0.9-Kb tandem duplication on chr.10p12.31 was misclassified as translocation by LUMPY but uncovered by the long-read analysis methods disclosed herein from a 12.9 Kb nanopore read. FIG. 14 is a visualization of a short tandem duplication detected by the disclosed long read analysis method. A 12.9 Kb nanopore read aligns to the reference genome as two overlapping segments of 11.4 Kb and 2.4 Kb with 86% and 83% identities (e2 value=0). This tandem duplication was misclassified as a translocation by the short read aligner BWA and SV identifier LUMPY. The alignments were visualized by Ribbon. This duplicated region is a dinucleotide (TA)n microsatellite repeat known to be highly variable in the human genome. See Layer, R. M., Chiang, C., Quinlan, A. R. & Hall, I. M., “LUMPY: a probabilistic framework for structural variant discovery”, Genome Biol. 15, R84 (2014). Despite the highly repetitive nature of this duplication, the disclosed long read analysis method can detect and accurately map the tandem duplication due to the alignment specificity offered by the long read and the algorithmic design.

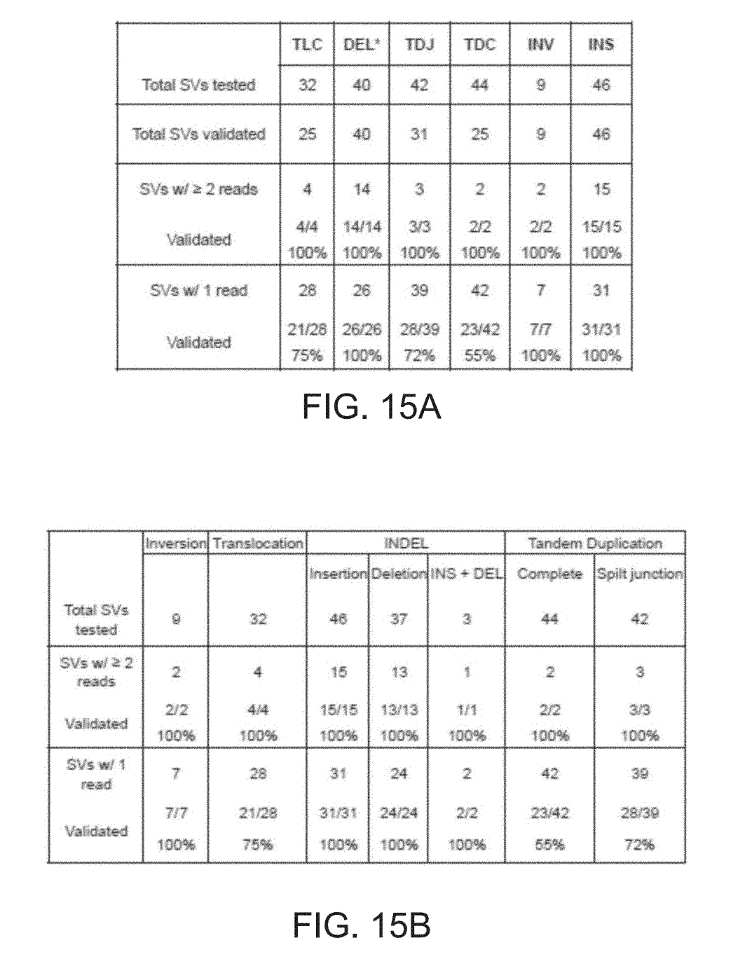

Validation tests were performed to confirm the accuracy of the long read analysis and structural variation determination method disclosed herein. Structural variations were validated via PCR across either identified breakpoint junctions (TLCs, INVs and TDJs) or full-length rearranged regions (INSs, DELs and TDCs). Overall, over 200 SV events were validated based on the presence of PCR-amplified products of the expected sizes. All (100%-40/40) of the predicted SVs that were supported by more than one long read were validated, while 136 out of 173 (79%) SVs that were supported by only a single long read were validated. Data is shown in FIGS. 15A and 15B are tables including numbers of structural variants and a summary of the variants from the different SV classes.

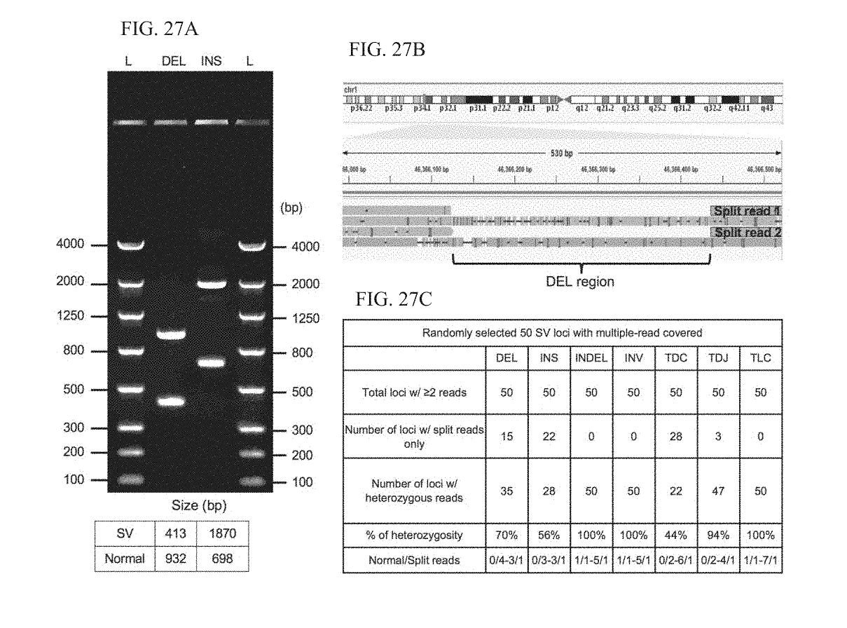

Multiple PCR fragments amplified from both normal and rearranged haplotypes were also observed, which suggested the presence of heterozygosity in SV-containing loci, see FIG. 27A. To quantify the extent of heterozygosity, 50 randomly selected rearranged lock covered by multiple reads from each SV class were examined and it was determined that the number of loci spanned by reads from both normal and variant haplotypes found in the same locus (see FIG. 27B). Extensive heterozygosity of SVs was observed among different classes, ranging from 44% in TDCs to 100% in INVs, INDELs, and TLCs (see FIG. 27C).

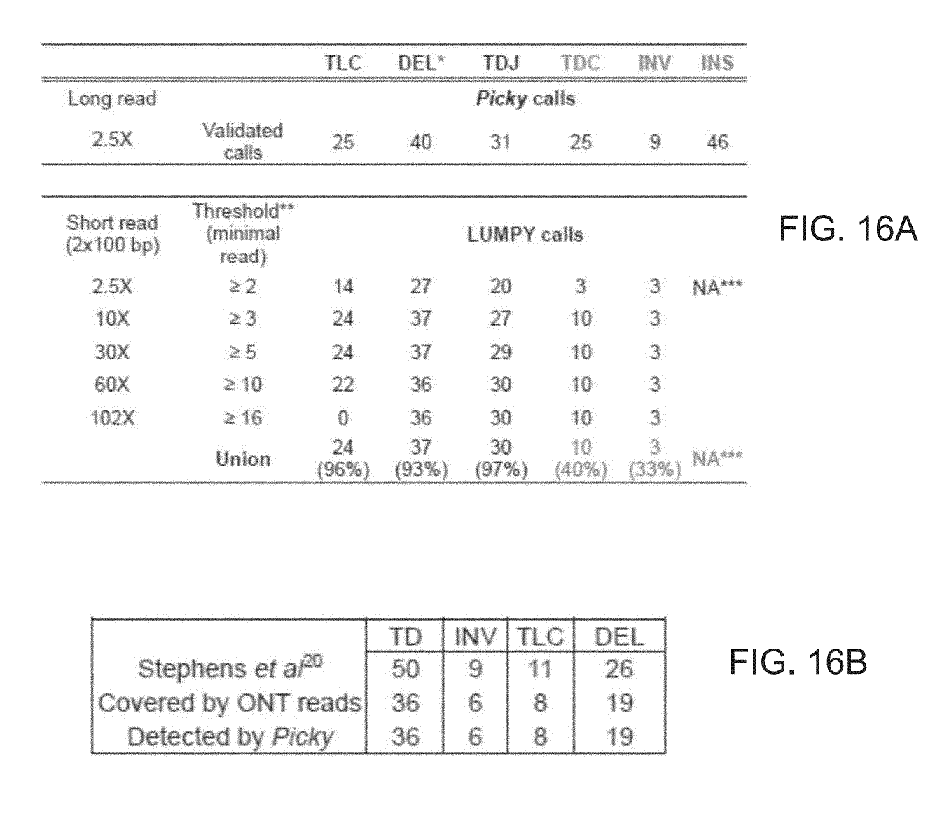

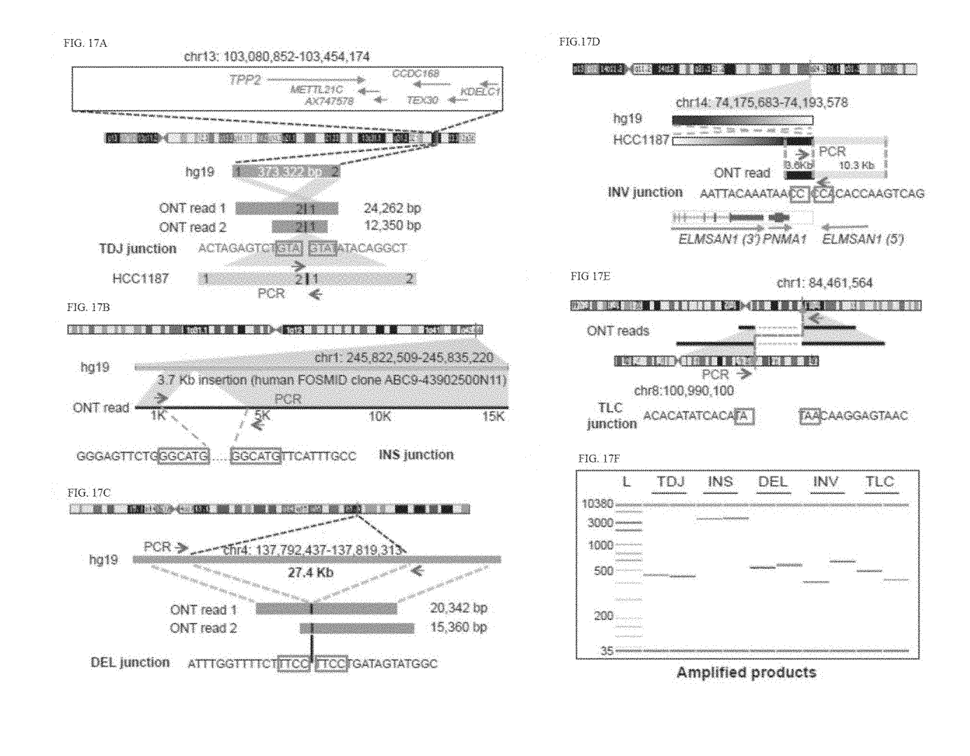

Using the 176 validated SVs as a reference data set, a specificity comparison was made between long read and short read analyses. As shown, short-read sequencing analysis by LUMPY could only accurately detect a subset of SV classes (TLC, TDJ and DEL) given sufficient coverage (>30×), but drastically underperformed in classifying short-span TDs (TDC) and inversions, and was unable to unambiguously define insertion events. FIG. 16A is a table of numbers of SVs identified by LUMPY from different depths of short-read data.

To further evaluate the sensitivity of long-read analysis method, tests were performed to determine whether the long-read analysis could detect and classify the SVs identified by a previous short-read data analysis. See Gazdar, A. F. et al., “Characterization of paired tumor and non-tumor cell lines established from patients with breast cancer”, Int. J. Cancer 78, 766-774 (1998). Excluding the 27 SV regions not covered by the long read data, all the remaining 69 SVs classified by the short-read analysis method were correctly classified by the long-read analysis method as well as shown in the table of FIG. 16B. Selective examples of the validated SVs and their breakpoint junctions are shown in FIG. 17A-F. This confirms that long read sequencing, combined with the long read analysis method disclosed herein, enables accurate genome alignment, resolves the organization of repetitive sequence regions, and is clearly superior to short read approaches in identifying a wide range types of SVs.

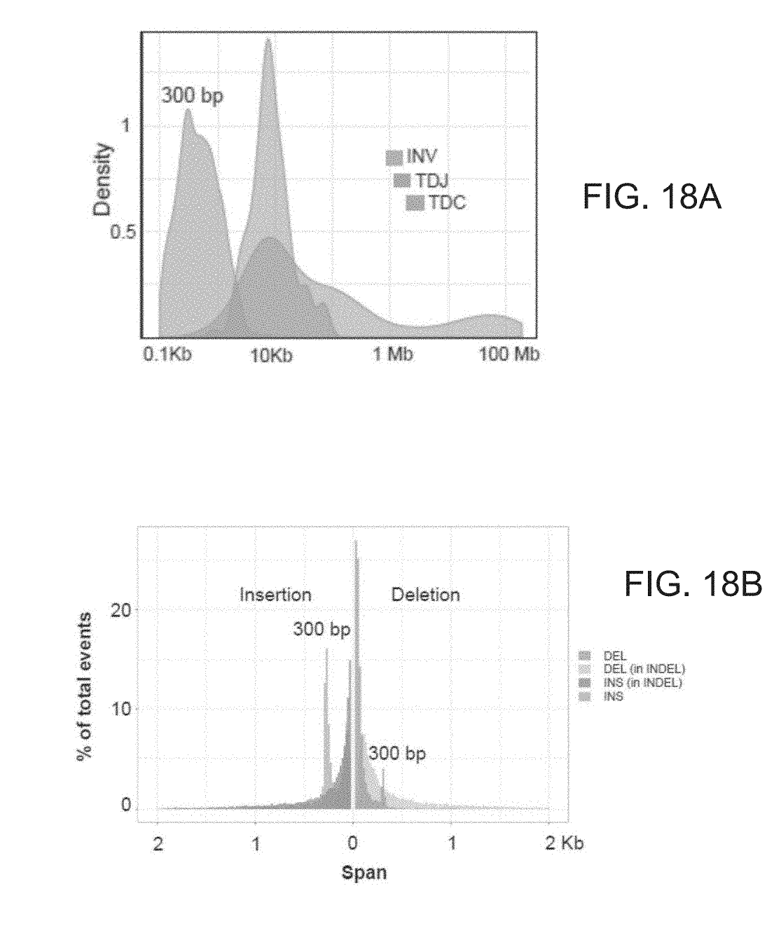

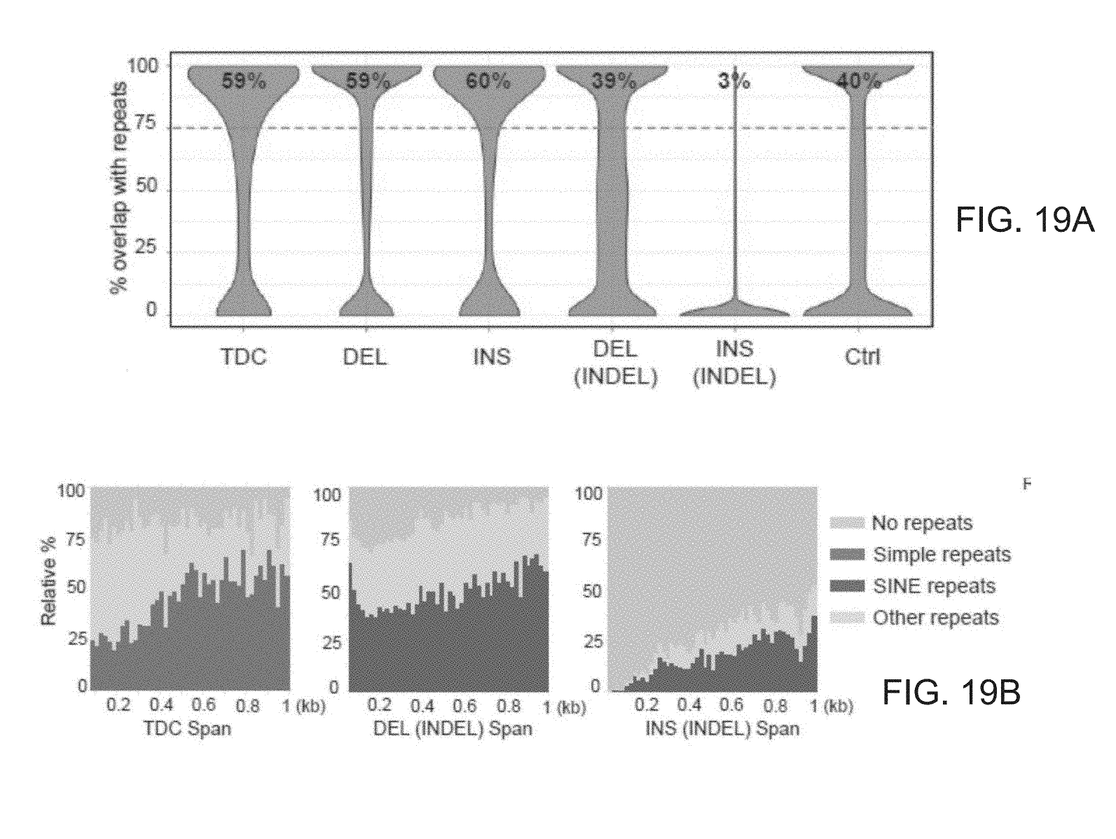

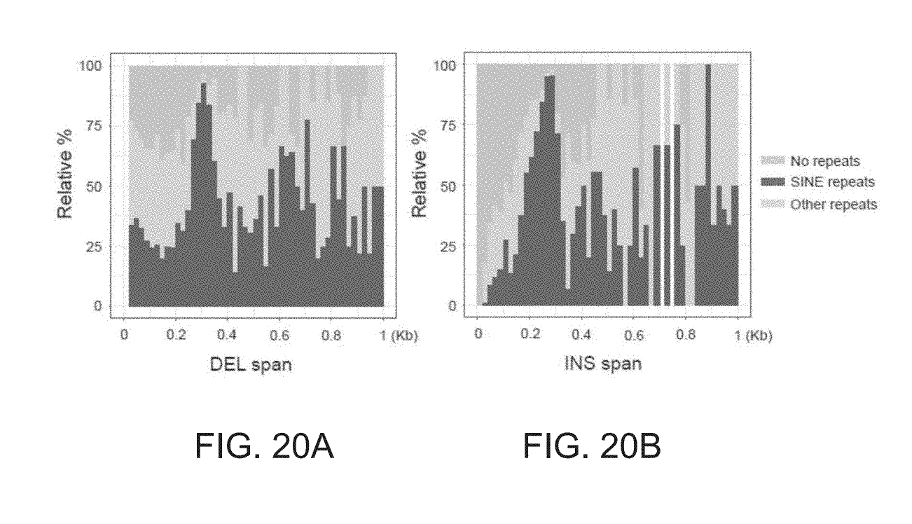

The structural variations identified in the HCC1187 genome exhibit a broad span distribution, ranging from 20 bp up to 100 Mb. FIGS. 18A and 18B are graphs showing span distributions of repeat-rich SVs and the presence of micro-insertions within SV junctions detected by the disclosed long-read method. FIG. 18A shows the Span distribution of INV, TDJ and TDC and FIG. 18B shows the span distribution of DEL, INS and INDEL. Compared to the short-read analysis, the long-read analysis disclosed herein uniquely detects short INSs, DELs, INDELs and TDCs through long reads spanning across the entire variable regions as shown by the span size distribution of the SVs. A vast majority of the 28,402 INSs and DELs and 3,332 TDCs span less than 1 Kb with notable peaks around 300 bp, suggesting that the SVs are enriched with repetitive sequences. Examination of the repeat content demonstrated that simple INSs, DELs and TDCs exhibited a bimodal distribution based on the fraction of the SVs overlapping with repetitive sequence regions. In 59-60% of the INSs, DELs and TDCs, more than 75% of the SV regions overlap with repetitive sequences. In comparison, in only 40% of the randomly selected genomic control regions of similar size distribution, more than 75% of their spans overlap with repeats. FIG. 19A is a graph showing fraction of regions overlapped with repeats among different SV classes. Further dissecting the types of repeats found across different SV types, it was determined that SINE and simple repeats are the predominant enriched repeat classes. FIG. 19B shows a set of graphs showing relative percentages of the major repeat types across different span sizes. FIGS. 20A and 20B are graphs showing relative percentages of repeats across different span sizes in simple DEL and simple INS, respectively. As indicated, small-size INSs, DELs and TDs account for the majority of the SVs detected in HCC1187 genome and these SVs are predominantly copy number variation in repetitive sequence regions.

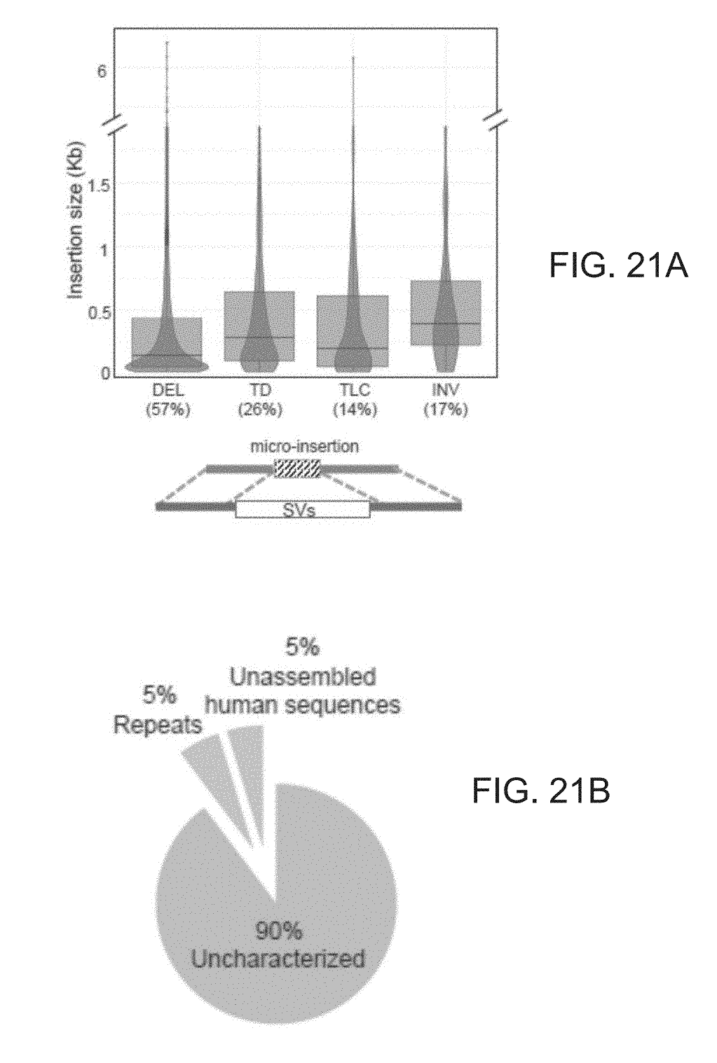

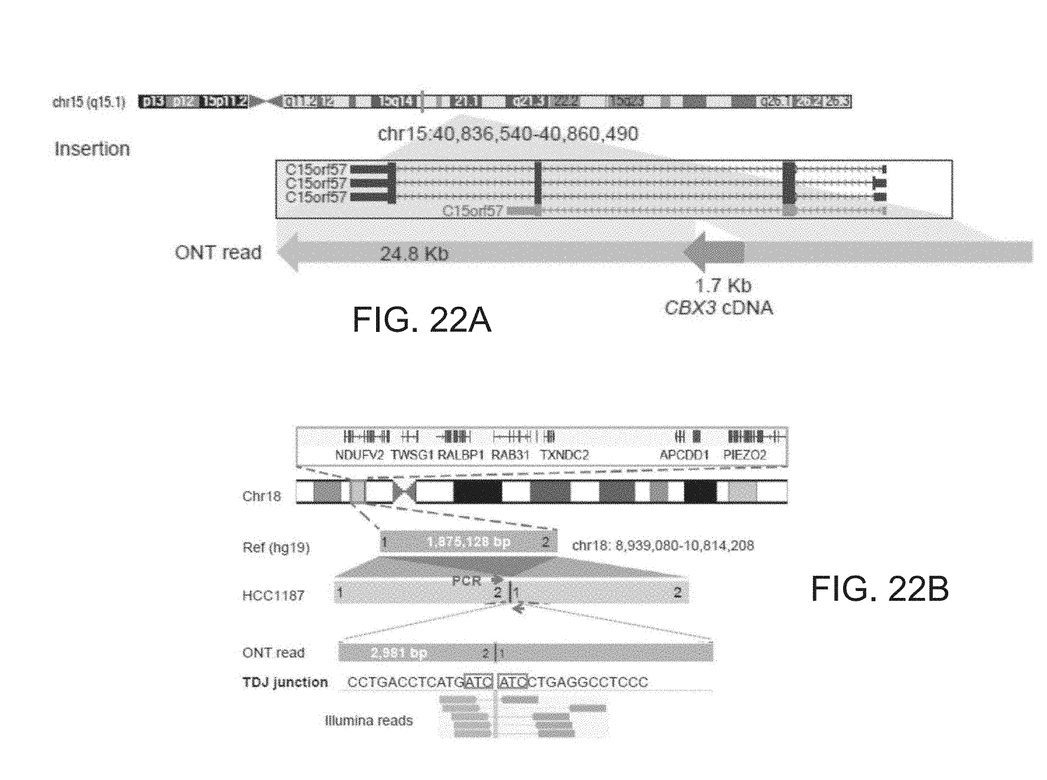

Split read linked alignment extensions aligned across SV junctions enable the long-read analysis methods disclosed herein to characterize breakpoint junctions in their entirety at nucleotide-resolution. A total of 66,660 breakpoint junctions from different SV types were examined, and the presence of additional non-aligned DNA sequences inserted within the breakpoints was observed. While these non-aligned DNA insertions were most frequently detected within the junctions of DELs (57%) and TDs (26%), they were also found in a subset of TLCs (14%) and INVs (17%) as shown in FIG. 21. The majority of these inserted sequences spans less than 500 bp, although some of them are as long as 6 Kb, and have no significant similarity to the reference human genome.

Applying the BLAST tool to these insertions against the NCBI non-redundant nucleotide database reveals that 90% of the inserted DNA pieces are completely novel with no homology to any known sequences, 5% overlap with known repetitive elements (mostly SINE/Alu), and the remaining 5% are derived from un-assembled human sequences, including newly emerged retrotransposed pseudogenes. FIG. 21B is a pie chart showing the identity of the microinsertions and FIG. 22A is an illustration of an insertion of a 1.7 Kb CBX3 retrotransposed pseudogene in chromosome 15 revealed by a 24.8 Kb read (WTD13:1125). The small size of the non-aligned insertions sequences and their lack of significant homology with any existing known sequences, are consistent with the “genomic shards” observed in a few selective rearrangement events. See Li, Y. C., Korol, A. B., Fahima, T., Beiles, A. & Nevo, “E. Microsatellites: genomic distribution, putative functions and mutational mechanisms: a review”, Mol. Ecol. 11, 2453-2465 (2002); Bignell, G. R. et al., “Architectures of somatic genomic rearrangement in human cancer amplicons at sequence-level resolution”, Genome Res. 17, 1296-1303 (2007). Formerly reported as rare events, these micro-insertions are thought to derive from non-templated DNA synthesis at the rearrangement junctions between chromosomal double-strand breaks. See Gazdar, supra. Besides the micro-insertions, short stretches (usually 2-6 nucleotides) of identical sequence, known as overlapping microhomology (see Cahill, D., Connor, B. & Carney, J. P., “Mechanisms of eukaryotic DNA double strand break repair”, Front. Biosci. 11, 1958-1976 (2006), were frequently spotted at SV breakpoint junctions as highlighted in FIG. 17 and FIG. 22B which is an illustration of a confirmed TDJ of 1.87 Mb on chromosome 18 revealed by a 3.0 Kb read (WTD02:4697).

In summary, the long-read SV determination method disclosed herein uncovers large number of variants in repetitive sequence regions and precisely characterizes breakpoint sequences.

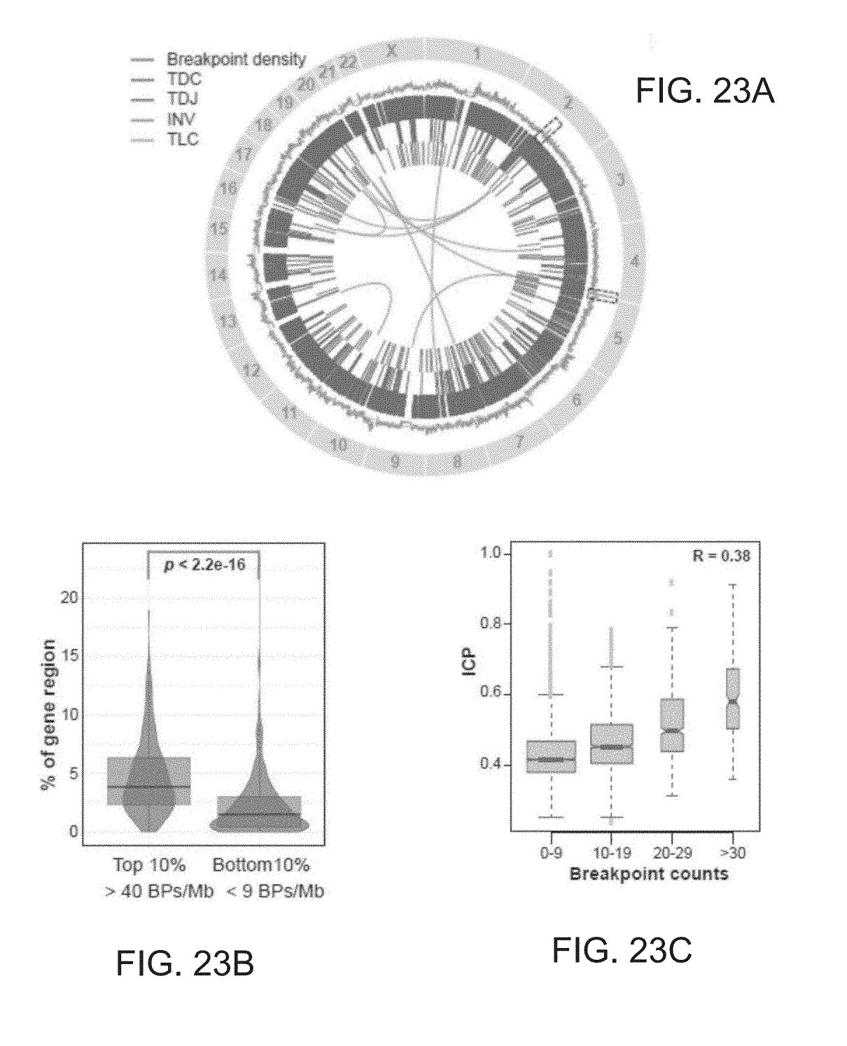

Furthermore, long-read analysis shows that the distribution of the large numbers of SVs in the HCC1187 genome reflects the highly jumbled nature of this genome. FIG. 23A is a circular chromosome chart that illustrates that genome-wide distribution of the SVs and their associated breakpoints density. From outer circle to inner circle: Red: indicates measured breakpoint density; Grey: indicates reference average density of 22 breakpoints/Mb; Blue: indicates TDC; Purple: indicates TDJ (with span size <20 Mb); Green: indicates INV; Magenta: indicates TLC (with pair counts ≥4) at 1 Mb bin size. From among the 1,911 TLCs, high frequency translocations between t(2; 19), t(2; 17), t(1; 8) and t(10:13) were consistent with the translocations previously described by SKY (spectral karyotyping). See Howarth, K. D. et al., “Array painting reveals a high frequency of balanced translocations in breast cancer cell lines that break in cancer-relevant genes”, Oncogene 27, 3345-3359 (2008). The density of breakpoint distribution across the genome was found to be associated with the fraction of the genome annotated with gene coding regions. Using 1 Mb genomic span as the bin size, 80 out of 107 (75%) of the gene-rich regions (>10% gene-annotated nucleotides) have ≥20 breakpoints; while 180 out of the 193 (93%) gene desert regions (zero annotated nucleotide) have ≤6 breakpoints. Across genomic regions with different breakpoint densities, the regions within the top 10% in breakpoint density (>40 breakpoints/Mb) have a significantly higher percent of nucleotides coding for genes than the bottom 10% breakpoint-poor regions (<9 breakpoints/Mb) (p<2.2e−16, Mann-Whitney test) as shown in FIG. 23B which is a graph showing a fraction of regions with transcribed genes in regions of the top and bottom 10% breakpoint densities. BP, indicates breakpoint. The P value was calculated by the Mann-Whitney test.

These results suggest that high transcription activity could impact genome fragility. Interestingly, two of the hyper-density breakpoint loci (2q21.3-2q22.1; 65 breakpoints/Mb and 4q35; 139 breakpoints/Mb; highlighted in FIG. 23A) had very high inter-chromosomal contact probability (ICP) values (within top 10 percentile of ICP) found in the GM12878 cell line. ICP, defined as the sum of a region's inter-chromosomal contact frequencies divided by its total contact frequencies from a nuclear ligation assay (Tethered Conformation Capture), has been used to describe the propensity of a region to form inter-chromosomal contacts within interphase nuclei. See Kalhor, R., Tjong, H., Jayathilaka, N., Alber, F. & Chen, L., “Genome architectures revealed by tethered chromosome conformation capture and population-based modeling”, Nat. Biotechnol. 30, 90-98 (2012). For example, the 4q35 subtelomeric region (chr4: 190,466,668-190,854,960) is located at the nuclear periphery (see Tam, R., Smith, K. P. & Lawrence, J. B., “The 4q subtelomere harboring the FSHD locus is specifically anchored with peripheral heterochromatin unlike most human telomeres.”, J. Cell Biol. 167, 269-279 (2004)) and 2q21.3-2q22.1 (chr2: 132,839,065-133,225,936) lies next to the vestigial centromere (see Avarello, R., Pedicini, A., Caiulo, A., Zuffardi, O. & Fraccaro, M., “Evidence for an ancestral alphoid domain on the long arm of human chromosome 2”, Hum. Genet. 89, 247-249 (1992)). This raises the possibility that chromosome regions with frequent exposure to other chromosome and/or residing at the exterior of a chromosome territory, could be more prone to chromosomal breaks compared to the protected regions deeper inside the chromosome territory. Further analysis on the whole genome level indicated a positive correlation between ICP and breakpoint count. FIG. 23C is a graph of ICP versus breakpoint counts and shows the trend of increasing ICP with increasing number of breakpoints. In the plots, the breakpoint and ICP were calculated for every chromosome segments of 138 HindIII sites. The ICP values were then grouped based on the breakpoint counts as indicated on the x-axis. The R value is the Pearson's correlation coefficient on the underlying, ungrouped data. For instance, the group with the highest breakpoint counts (>30) exhibits higher ICP values (p-value <1.6e−16, Mann-Whitney one-sided non-parametric test) than the group with the lowest breakpoint counts (<10). These observations further support the notion that intermingling of chromatin organization directly influences the structural properties associated with elevated frequency of DNA double strand breaks. See Branco, M. R. & Pombo, A., “Intermingling of chromosome territories in interphase suggests role in translocations and transcription-dependent associations”, PLoS Biol. 4, e138 (2006); Tjong, H. et al., “Population-based 3D genome structure analysis reveals driving forces in spatial genome organization.” Proc. Natl. Acad. Sci. USA 113, E1663-1672 (2016).

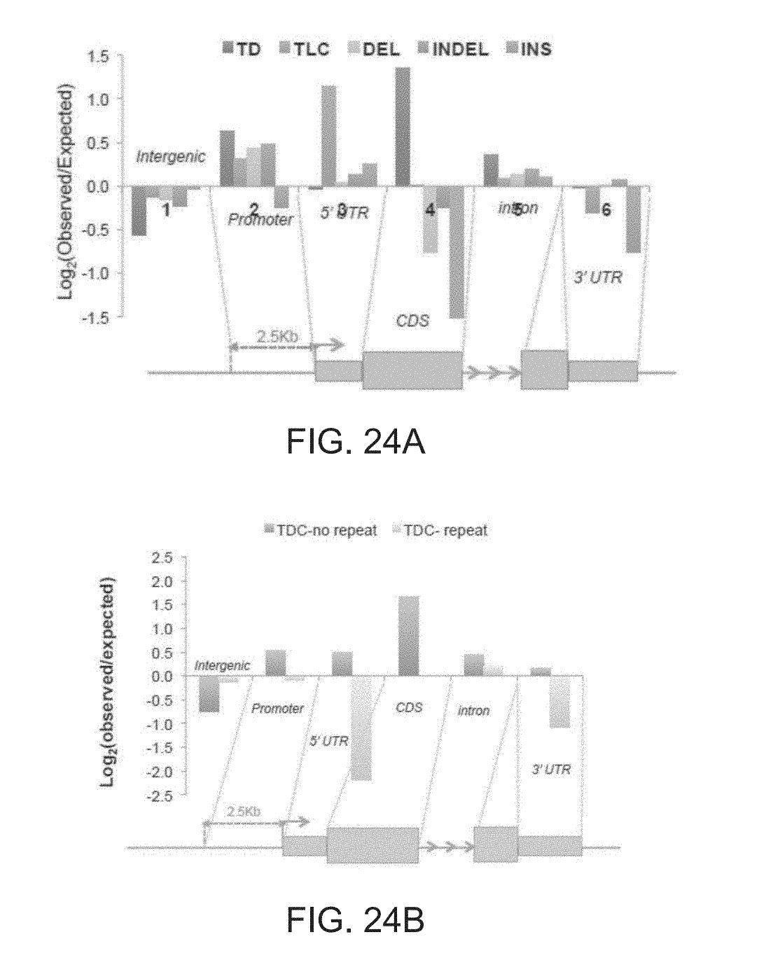

In addition, the high frequency of SVs associated with the interconnected chromatins of high gene density further implicates linkage between genome structure and transcriptional regulation. The distribution of different SV associated-breakpoints among intergenic, coding sequence (CDS), promoter (2.5 Kb upstream of TSS), 5′ and 3′ un-translated regions (UTRs), and introns shown in FIG. 24A were investigated to shed light on this linkage. Significant enrichment of breakpoints was found in promoters and 5′ UTR for most of the SV types, particularly the TLC and TDs. In contrast, CDS and 3′ UTR were largely depleted of most of the SVs except TDs. Such patterns suggest that the potential impact of SVs is to modulate gene transcription by altering regulatory elements in promoters and 5′ UTR while minimizing their detrimental effects on functional protein integrity or RNA stability.

Interestingly, repeat-rich versus repeat-poor TDs exhibited contrasting distribution patterns as indicated in FIG. 24B. Breakpoints in the repeat-poor TDs generated by NHEJ or microhomology-mediated end joining (MMEJ) were found at higher frequency in all compartments of gene regions, particularly in CDS. This is consistent with previous findings of short TDs (Tandem Duplicator Phenotype; TDP) in TNBC, ovarian cancer, and endometrial carcinoma where tumor suppressor genes statistically more frequently disrupted than random. See Menghi, supra. Long-read analysis therefore indicates that different repair mechanisms of tandem duplications, homologous recombination (HR) or NHEJ/MMEJ, have different functional consequences in cancer biology.

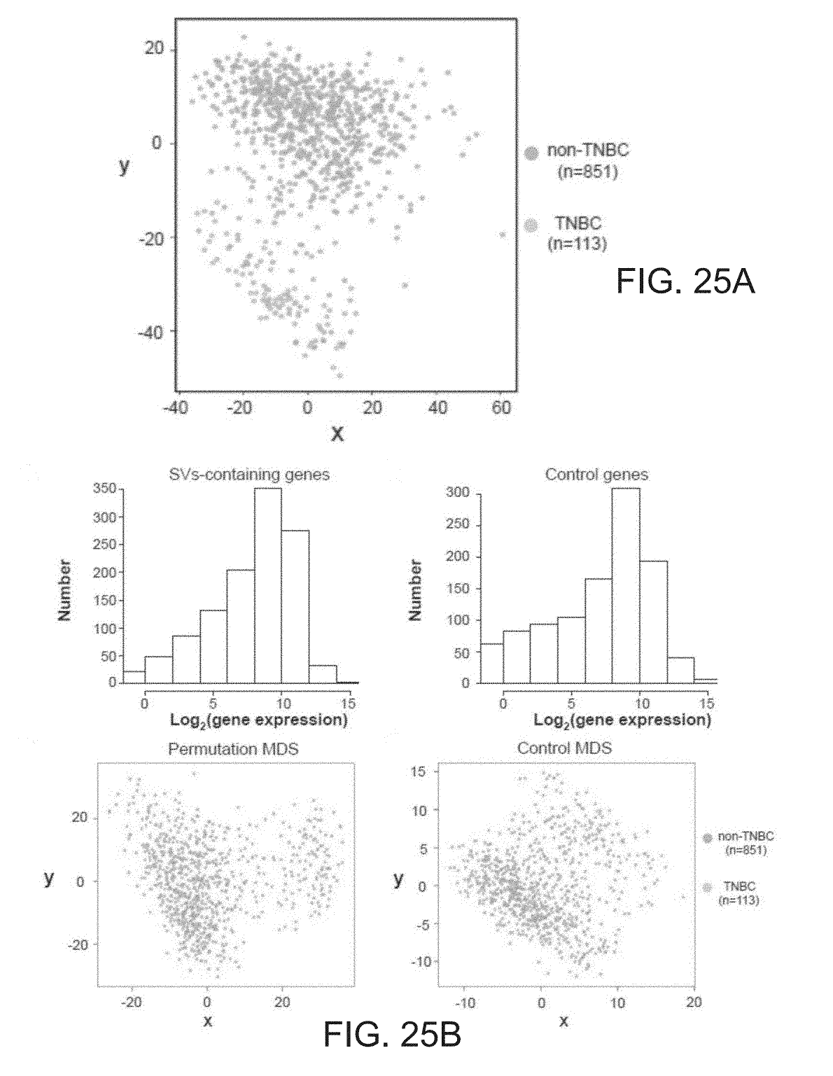

SVs occurring in promoters/regulatory elements can selectively lead to oncogene activation or tumor suppressor gene inactivation. Such effects on gene expression are likely to be cancer pathway or origin specific. To test this, the genes affected by the SVs were determined and the expressions from 113 TNBC and 851 non-TNBC tissues of the breast carcinoma w(BRCA) dataset within the cancer genome atlas (TCGA) were examined. See Chung, I. F. et al., “DriverDBv2: a database for human cancer driver gene research”, Nucleic Acids Res. 44, D975-979 (2016). In contrast to the control genes and with permutation, the expression of 1,260 coding genes disrupted by the major SV classes (INDEL and TD) effectively distinguished TNBC from non-TNBC types. This is illustrated by the multidimensional scaling (MDS) plot shown in FIGS. 25A and 25B, highlighting the functional impacts of SV analysis and its link to tumor molecular classification.

As described above, the long-read structural variation method disclosed herein enables detection of a full spectrum of structural variants in a highly complex cancer genome model. Experimental results demonstrate that long read sequencing offers superior performance to high depth, short-read analysis in specificity for SV detection, even at a modest depth. The specificity of the long read-to-genome alignment uncovers short span SVs residing in different repetitive elements, which are highly abundant but largely understudied by existing approaches. Repetitive elements are known to provide architectural framework in genome organization and as a major source of variation inducing human diseases. See Shapiro, J. A. & von Sternberg, R, “Why repetitive DNA is essential to genome function”, Biol. Rev. Camb. Philos. Soc. 80, 227-250 (2005); Padeken, J., Zeller, P. & Gasser, S. M., “Repeat DNA in genome organization and stability”, Curr. Opin. Genet. Dev. 31, 12-19 (2015). However, the lack of knowledge of SVs localized to these repetitive regions severely limits the analysis of important structural mutations in cancer, especially those SVs in cancers with intact homologous recombination mechanisms.

The long read breakpoint analysis disclosed herein suggests the linkage between the propensity of inter-chromosomal connectivity and frequency of genomic lesions. Nuclear regions with high transcriptional activity are shown to have extensive inter-chromatin contacts and intermingling between chromatin territories can influence translocation efficiency. See Kahlor et al., Branco et al, cit. supra. Therefore, the accessibility and conformation in active chromatin domains may provide the structural basis of genome fragility. The preferential enrichment of breakpoints in the regulatory repertoire of the genome further implicates a potential mechanism in which genome rearrangement can reconfigure the transcriptional program in the cancer transformation process. Expanding the high-resolution of SV analysis throughout tumorigenesis using long read analysis can further our understanding of the homeostasis between genome architecture, variation and carcinogenesis.

Long-read sequencing possesses many unique features that can improve upon the current state of SV detection. Yield from long read sequencing techniques such as nanopore sequencing has dramatically increased over the past year with higher sequencing speed and pore stability. Furthermore, multiple strategies have been devised in parallel to improve base identification accuracy, including a new base identifier called “Scrappie”. See Jain, M. et al., “Nanopore sequencing and assembly of a human genome with ultra-long reads”, preprint at bioRxiv https://doi.org/10.1101/128835 (2017). With the continuous progress made on throughout, accuracy and analytic tools, genome-wide haplotype specific SV detection can be attempted to interrogate the diversity and complexity of cancer genome variation. Given the superior alignment specificity, higher resolution and broader utility of single-molecule long-read data, we anticipate that there will be soon a paradigm shift with respect to sequencing approaches for genome structural analysis; this shift will likely reveal new insights in the dynamics of SVs and the mechanisms of their generation during tumorigenesis.

All publications, patents, and patent applications mentioned in this specification are herein incorporated by reference. To the extent publications and patents or patent applications incorporated by reference contradict the disclosure contained in the specification, the specification is intended to supersede and/or take precedence over any such contradictory material.

It is to be understood that any functional details disclosed herein are not to be interpreted as limiting the systems and methods, but rather are provided as a representative embodiment and/or arrangement for teaching one skilled in the art one or more ways to implement the methods.

It is to be further understood that like numerals in the drawings represent like elements through the several figures, and that not all components and/or steps described and illustrated with reference to the figures are required for all embodiments or arrangements

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

While the invention has been described with reference to exemplary embodiments, it will be understood by those skilled in the art that various changes may be made and equivalents may be substituted for elements thereof without departing from the scope of the invention. In addition, many modifications will be appreciated by those skilled in the art to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method of determining the presence of a novel structural variation in a genome, comprising:
a) providing a plurality of long-read genome sequences derived from a genome;
b) aligning said long-read genome sequences with a reference genome sequence to produce a plurality of alignments by using alignment parameters configured for low sequence similarity;
c) filtering said plurality of alignments by removing low quality alignments to yield remaining alignments based on an alignment parameter;
d) ranking said remaining alignments based on (i) a probability of random hit, and (ii) an alignment score;
e) selecting a seed candidate alignment, wherein said seed candidate alignment has a highest rank as compared to the remaining alignments;
f) linking said seed candidate alignment with said remaining alignments to create a linked alignment extension having a combined alignment score, said linking is performed by using read coordinates of said seed candidate alignment in vicinity to read coordinates of said remaining alignment to cover a maximal sequence length;
g) repeating step e) and step f) to obtain a plurality of linked alignment extensions;
h) selecting from step g) a best linked alignment extension that has a highest combined alignment score; and
i) determining whether a novel structural variation is present in said genome, wherein when said best linked alignment extension contains multiple linked alignments that are mapped to a single locus is indicative of the presence of a novel structural variation.

2. The method of claim 1, wherein said plurality of long-read genome sequences are derived from a human genome.

3. The method of claim 1, wherein said plurality of long-read genome sequences are derived from a mouse genome.

4. The method of claim 1, wherein during said filtering step c), a particular alignment of the plurality of alignments is discarded when the particular alignment has i) an EG2 value above an EG2 threshold, or ii) a percentage identity below a % identity threshold in comparison to the reference genome.

5. (canceled)

6. The method of claim 1, wherein during said alignment step b), said alignment parameters configured for low sequence similarity include a match reward score of 1, a mismatch penalty score of −1, a gap open score of zero, and a gap extension score of 2.

7. (canceled)

8. The method of claim 1, further comprising:
determining whether a linked alignment extension with a second highest alignment score overlaps more than 95% of best linked alignment extension,
wherein if the second linked alignment extension with a second highest alignment score overlaps more than 95% of best linked alignment extension, no structural variation is indicated.

9. The method of claim 1, wherein step f), the remaining alignment is linked to the seed candidate alignment and any other alignments already combined with the seed candidate alignment when the remaining alignment extends coverage of the seed candidate alignment and any previously combined alignments by at least 200 bases and the overlap between the remaining alignment and the seed candidate and any previously combined alignments is less than 50% of either the remaining alignment or the seed candidate and any previously combined alignments.

10. The method of claim 1, further comprising:
j) classifying the novel structural variation when it is determined that a novel structural variation is present.

11. The method of claim 10, wherein the novel structural variation is classified as an insertion (INS), a deletion (DEL), an indel (INDEL), an inversion (INV), a tandem duplication (TDJ), a tandem duplication complete (TDC), a cis-chromosomal translocation (CTLC), or an inter-chromosomal translocation (TTLC).

12. The method of claim 10, further comprising:
determining whether said novel structural variation is a deletion; and
determining whether said novel structural variation occurs in a homopolymer,
wherein if it is determined that novel structural variation is a deletion that occurs in a homopolymer, the deletion is not counted as a novel structural variation.

13. The method of claim 11, wherein step j) includes:
calculating a first distance parameter (sDiff) based on reference genome coordinates; and
calculating a second distance parameter (qDif) based on long read coordinates.

14-15. (canceled)

16. The method of claim 13, wherein during said step of classifying j), the novel structural variation is classified as an indel (INDEL) when sDiff ≥ about 20 and qDiff ≥ about 20.

17. The method of claim 13, wherein in step j), the novel structural variation is classified as an inversion (INV) if said multiple linked alignments that are mapped to a single locus are from a single chromosome and have different orientation.

18. The method of claim 13, wherein in step j), the novel structural variation is classified as a translocation (TLC) if said multiple linked alignments that are mapped to a single locus are from different chromosomes.

19. The method of claim 13, wherein in step j), the novel structural variation is classified as a tandem duplication complete (TDC) if said multiple linked alignments that are mapped to a single locus capture a complete duplicated fragment and sDiff ≤−100.

20. The method of claim 13, wherein in step j), the novel structural variation is classified as a junction tandem duplication (TDJ) if said multiple linked alignments that are mapped to a single locus capture ends of a duplicated fragment.

21. The method of claim 1, further comprising, after step c):
determining whether said remaining alignments cover at least seventy percent of a total span of said plurality of long-read genome sequences; and
stopping processing if the remaining alignments do not cover at least seventy percent of a total span of said plurality of long-read genome sequences.

22. The method of claim 1, wherein step f) includes determining whether i) a beginning long read coordinate of a remaining alignment overlaps or is in the vicinity of a long-read coordinate of a 3′ end of the seed candidate alignment, or ii) an end long read coordinate of a remaining alignment overlaps or is in the vicinity of a long-read coordinate of a 5′ end of the seed candidate alignment.

23. The method of claim 1, wherein the plurality of long read genomic sequences each have a length of over 1,000 bases.

24. A method of determining the presence of a novel indel (INDEL) in a genome, comprising:
a) providing a plurality of long-read genome sequences derived from a genome;
b) aligning said long-read genome sequences with a reference genome sequence to produce a plurality of alignments by using alignment parameters configured for low sequence similarity;
c) filtering said plurality of alignments by removing low quality alignments to yield remaining alignments based on an alignment parameter;
d) ranking said remaining alignments based on (i) a probability of random hit, and (ii) an alignment score;
e) selecting a seed candidate alignment, wherein said seed candidate alignment has a highest rank as compared to the remaining alignments;
f) linking said seed candidate alignment with said remaining alignments to create a linked alignment extension having a combined alignment score, said linking is performed by using read coordinates of said seed candidate alignment in vicinity to read coordinates of said remaining alignment to cover a maximal sequence length;
g) repeating step e) and step f) to obtain a plurality of linked alignment extensions;
h) selecting from step g) a best linked alignment extension that has a highest combined alignment score; and
i) determining whether a novel structural variation is present in said genome, wherein when said best linked alignment extension contains multiple linked alignments that are mapped to a single locus is indicative of the presence of a novel structural variation;
j) classifying the novel structural variation as an indel when structural variation a first distance parameter (sDiff) based on reference genome coordinates is greater than or equal to twenty bases a second distance parameter (qDif) based on long read coordinates is also greater than or equal to twenty bases.
